(19) United States
(12) Patent Application Publication
(10) Pub. No.: US 2017/0293984 A1
(43) Pub. Date: Oct. 12, 2017

(54) METHOD, APPARATUS AND SYSTEM FOR CONSUMER PROFILING IN SUPPORT OF FOOD-RELATED ACTIVITIES

(71) Applicant: Kitchology, Inc., Wilmington, DE (US)

(72) Inventors: Steve Goldberg, Delray Beach, FL (US); Alain Briancon, Germantown, MD (US); Ian Durham, Kennebunk, ME (US); Iris Sherman, Rockville, MD (US); John Ellsworth, Derry, NH (US); Ryan B. Harvey, Lanham, MD (US); Barbara Boyce, Newark, DE (US); Ian Speers, Phoenixville, PA (US); Dennis Bonilla, Phoenix, AZ (US); Christopher Peterson, Greece, NY (US); Jenny Sprague, Gray, ME (US); Thomas Scholl, Bethesda, MD (US)

(73) Assignee: Kitchology, Inc., Wilmington, DE (US)

(21) Appl. No.: 15/634,762

(22) Filed: Jun. 27, 2017

Related U.S. Application Data
(62) Division of application No. 14/757,994, filed on Dec. 23, 2015.
Application No. 14/757,994 is a continuation-in-part of application No. 13/734,541, filed on Jan. 4, 2013, now abandoned.
Application No. 14/757,994 is a continuation-in-part of application No. 14/259,837, filed on Apr. 23, 2014, now abandoned.
Application No. 14/757,994 is a continuation-in-part of application No. 14/259,755, filed on Apr. 23, 2014, now abandoned.
(60) Provisional application No. 61/583,432, filed on Jan. 5, 2012.
(60) Provisional application No. 61/815,398, filed on Apr. 24, 2013.
(60) Provisional application No. 61/815,397, filed on Apr. 24, 2013.
(60) Provisional application No. 61/815,398, filed on Apr. 24, 2013.
(60) Provisional application No. 61/815,397, filed on Apr. 24, 2013.
(60) Provisional application No. 62/096,281, filed on Dec. 23, 2014.

(51) Int. Cl. G06Q 50/12; G06Q 10/02

(52) U.S. Cl. CPC G06Q 50/12; G06Q 10/02; G06Q 30/0241

(57) ABSTRACT

A profile manager (PM) server receives a Food Profiling Request Message (FPREM), from a consumer's Wireless Receive/Transmit Unit (WRTU), responsive to a WRTU-initiated food-related event (FEP). The FPREM is created from information in an Input Mobile Element (IME) sent to the WRTU from a FEP provider responsive to its initiation. The IME includes code providing a link to other code directing the FPREM to the PM server. The FPREM includes an identifier for the FEP (FEID) and a consumer food profile class (CFPC). The PM server searches a lookup table for the FEID and the CFPC to determine consumer-pre-authorized attributes for sharing in association with the FEP corresponding to the FEID. The PM server sends, to a processing system associated with the FEP (FEPPS), a Food Profiling Request Response (PFRER), which includes the FEID and one of the attributes or an indication that no attributes are authorized for sharing.

### CROSS REFERENCE TO RELATED APPLICATIONS

This application is a Division of U.S. patent application Ser. No. 14/757,994, filed on Dec. 23, 2015, which is a Continuation-in-Part of U.S. patent application Ser. No. 13/734,541, filed on Jan. 4, 2013, which claims the benefit of U.S. Provisional Patent Appln. No. 61/583,432, which was filed on Jan. 5, 2012, the contents of which are hereby incorporated by reference herein. U.S. patent application Ser. No. 14/757,994 is also a Continuation-in-Part of U.S. patent application Ser. No. 14/259,837, filed on Apr. 23, 2014, which claims the benefit of U.S. Provisional Patent Appln. Nos. 61/815,397 and 61/815,398, which were filed on Apr. 24, 2013, and is a Continuation-in-Part of U.S. patent application Ser. No. 14/259,755, filed on Apr. 23, 2014, which claims the benefit of U.S. Provisional Patent Appln. Nos. 61/815,397 and 61/815,398, which were filed on Apr. 24, 2013, and also claims the benefit of U.S. Provisional Patent Application No. 62/096,281, filed Dec. 23, 2014, the contents of which are hereby incorporated by reference herein.

### BACKGROUND

The introduction of the internet has impacted the food industry dramatically by enabling the digitizing of key information, their search and customization. This transformation has been accelerated through the introduction of smartphones that have become, along with keys and wallet, the one thing everyone grabs leaving home in the morning. Whether at restaurants, grocery stores or kitchens, smartphones have allowed digital content to enhance, disrupt, or replace traditional businesses and media. Food labels and recipes have moved from the respective realms of food packaging and cookbooks to the internet, and various apparatuses are used to access them (e.g., computers, tablets, smartphones, and specialized devices).

### SUMMARY

Methods, apparatus and systems are described. A method, implemented in a Food Event Processing Platform, includes establishing communication with a Wireless Receive/Transmit Unit (WRTU) attempting to process a food-related event (FE). One or more micro-service software components (MSSCs) of the FEPP are identified to process the FE. Information is obtained about a user of the WRTU that was deduced from information regarding transactions engaged in via the WRTU, and FE-related attributes are communicated to the MSSCs. It is determined whether affirmative action from the user is required. If so, a food event involvement trigger (FEIT), including a request for the affirmative action, is sent to the WRTU. A response to the FEIT is received, processed and forwarded to the MSSCs for processing. If the response is positive, the deduced information is provided to a processing system associated with a provider of the FE so it can begin processing the FE.

### BRIEF DESCRIPTION OF THE DRAWINGS

A more detailed understanding may be had from the following description, given by way of example in conjunction with the accompanying drawings wherein:

FIG. 1 is a diagram of a food cycle with constituent parts for procurement and consumption, and implication for the management of food related information by a Food Event Processing Platform (FEPP);

FIGS. 2a and 2b are diagrams showing the different users and components of a FEPP supporting need-based and profile-based food management services;

FIGS. 3a and 3b are diagrams showing the Food Event Involvement Trigger (FEIT) logic and knowledge manager supporting need-based and profile-based food management services; and

FIG. 4 is a diagram of an example FEPP that may provide anonymized profile information directed by a Wireless Receive/Transmit Unit (WRTU) such as a smartphone;

FIG. 5 is a flow diagram of an example method for consumer profiling in support of food-related activities;

FIG. 6 is a flow diagram of another example method for consumer profiling in support of food-related activities;

FIG. 7 is a flow diagram of another example method for consumer profiling in support of food-related activities; and

FIG. 8 is a flow diagram of another example method for consumer profiling in support of food-related activities.

### DETAILED DESCRIPTION

Food activities are numerous, grounded in routines and repetitious/cycling in nature. We refer to the ensemble (set) of food activities as a food cycle. We refer to a Food Event (or food moment) as events in the food cycle. These include, but are not limited to, checking inventory, making a shopping list, delegating the shopping, selecting a store, driving to a store, logging in to an online store, navigating through the store, shopping for items, redeeming coupons, paying, delivering the food, having the food delivered (including subscription kits), planning meals, searching a recipe, modifying a recipe, preparing to cook, cooking, recording cooking issues, setting the table, eating, selecting a restaurant, making a reservation for a restaurant, selecting items at restaurant, paying for them, getting food delivered, and sharing the experience with others (in person or, increasingly, through social networks).

An ingredient is a substance part of a mixture, which may be a food item (or a dish) realized using a recipe. A recipe may be the process used to create a mixture. Ingredients, along with preparation steps, are the cores of recipes, whether the recipe is used to realize a food item at home, at a store, at a restaurant, or in a brand manufacturing plant. Ingredients may be organized based on type, origin, species, variety and sub-variety depending on a level of enthusiasm and knowledge.

Most consumers have specific likes and dislikes for ingredients that may impact their food event choices, whether eating at home or ordering at restaurants. While those preferences are often explicitly known to members of a family or living circles, they may not be known or shared outside these immediate circles.

Many consumers manage their diets based on medical, ethnic or chosen lifestyles. Besides overall calorie intake and mix of nutrition types, managing these diets may be based on ingredients that should be avoid or emphasized.

According to Food Allergy Research and Education, as many as 15 million people have food allergies in the United States. Allergens may be protein or non-protein ingredients that are capable of inducing allergy or a specific hypersensitivity. Food allergy is an important public health problem that affects children and adults and may be increasing in prevalence. At the very least, it is increasing in consumer awareness.

Eight foods account for 90% of all food-allergic reactions: milk, eggs, peanuts, tree nuts (e.g., walnuts, almonds, cashews, pistachios, and pecans), wheat, soy, fish, and shellfish. Although childhood allergies to milk, egg, wheat and soy generally resolve in childhood, they appear to be resolving more slowly than in previous decades, with many children still allergic beyond age 5 years. Allergies to peanuts, tree nuts, fish, or shellfish are generally lifelong allergies. Despite the risk of severe allergic reactions, there is no current treatment for food allergies: the disease can only be managed by allergen avoidance or treatment of symptoms.

According to the Journal of the American Medical Association, one American in three believes they or their children have a food intolerance. Because patients frequently confuse non-allergic food reactions, such as food intolerance, with food allergies, there is an unfounded belief among the public that food allergy prevalence is higher than it is. It is estimated that 70 million US residents manage a food intolerance.

There are 26 million Americans with diabetes and 86 million with pre-diabetes. 47 million Americans are on some kind of weight loss diet and 23 million are vegetarians/vegans. 12 million Americans care about Kosher food (1 million all year long) and 50 million look for organic food items on a regular basis. 20 million of elderly Americans have specialized dietary needs.

Managing food allergies, intolerances or special diets is referred to herein as managing Profile Driven Food Lifestyles (PDFLs). Clearly, to manage a PDFL, one needs to adapt food activities (e.g., food events and food oriented events) in an easy, custom, private, manner. The totality or the near totality of the food experience is of clear interest to people managing PDFL.

The difficulty involved in managing PDFL has not been resolved by existing solutions. This is true for a multitude of reasons, the most immediate being that food activities are performed by a multitude of consumers and suppliers. No one platform can possibly capture the entirety of the commercial transactions associated with a consumer. For example, users do not shop at a single grocery store every single day, they do not eat every single meal at the same restaurant, and they do not eat with the exact same people every day. No current platform can integrate all these activities into a single system without creating a massive database and privacy nightmare let alone a viable rollout strategy.

Let us examine the existing challenges of making food events relevant to PDFL management. For example, for home prepared meals, in the US alone, $1 trillion is spent on food at home. 250,000 stores compete for this consumer business. At home, in the kitchen, recipes have gone digital. Allrecipes.com, Yummly, Kitchology, and Fooducate are but examples of this migration from paper recipes to electronic access. The benefits to electronic recipes include universal access without the need of a plethora of physical paper products nearby and ready access to expanded and new instances of the subject matters.

Further, ingredients are listed as quantitative ingredients. Food labels are essential as consumers become more dependent on processed, consumer packaged foods (part of the broader Consumer Packaged Goods) because, unlike the purchase of perishable items such as fruits, vegetables, meat or staples, the composition of such products cannot readily be determined by visual inspection. For example a consumer buying a packaged food product that contains fruit cannot, without a label, determine how much fruit is contained in the package.

Two important food label systems used in the US are universal product codes (UPC) and price look-up (PLU) codes. They are typically attached or printed on the ingredient being purchased.

A UPC is used by manufacturers to identify products. A UPC code generally has two parts: numbers, which people can read, and a series of bars that can be scanned and tracked by computers. The numbers generally indicate both the manufacturer and the specific product (or stock-keeping unit (SKU)). The UPC for a 6-pack of strawberry yogurt, a single strawberry yogurt, and single blueberry yogurt from the same manufacturer are different. Scanning the UPC code is usually done at cash registers to tally purchase information as well as create a profile (for some consumers) of their purchase choices. Quite often, this profile is not shared with the consumer.

PLU codes are four or five-digit identification numbers affixed to produce items. They are typically in the 3000-4999 range and identify the type of bulk produce, including the variety. The PLU Code for two bananas and one banana are the same. This means that serving information is not readily available based on PLU. Scanning the PLU code is usually done at cash registers to tally purchase information as well as create a profile (for some consumers) of their purchase choices. This information is typically not shared with the consumers or with other suppliers supplying the consumers. This is often for competitive reasons.

Nutritional information includes elements of the US basic food panel information, called the nutrition facts panel. The label begins with a standard serving measurement; calories are listed second; and then a breakdown of the constituent elements follows. Usually all 15 nutrients are shown: calories, calories from fat, fat, saturated fat, trans fat, cholesterol, sodium, carbohydrates, dietary fiber, sugars, protein, vitamin A, vitamin C, calcium, and iron. If a food has an insignificant amount (less than 1 gram or zero) of a nutrient, then it does not need to be listed on the nutrition facts panel. The design of this food panel is heavily regulated and cannot be arbitrarily modified.

Going beyond the general concept of listing ingredients and some information related to them per food labels, the U.S. Provisional Patent Application No. 61/815,397), which is hereby incorporated by reference as if fully set forth herein, describes the implementation of dynamic and customized food labels. Likewise going beyond the general concept of recipes in regard to ingredients and cooking procedures, U.S. Provisional Patent Application No. 61/815,398, which is hereby incorporated by reference as if fully set forth herein, describes a dynamic structure suitable to provide extensive information generally available through various means and to allow the customization of the information to the consumer's likes and needs.

Knowledge about ingredients used in restaurants or catering services is even more difficult for a user to obtain since restaurants do not readily publish their recipes nor do they know what additives have been introduced by their suppliers. Americans spend $600 billion on restaurant each year. 175 million Americans eat a meal prepared outside the home at least once a week. Helping the consumers deal with nutrition and allergy as general welfare is a key function of governments around the world. These efforts focus on food purchase for home use, leaving restaurants, catering services, and cafeterias sorely lacking.

The advent of smartphones with high-speed internet access has introduced new ways to manage PDFLs. Access to a broad range of information, tailored to consumer preferences and often rendered through a customized application (mobile app), allows some improvement in the management of PDFLs. A key element of smartphone is the ability to track location of use and track use of specific applications. This insight can be used to greatly enhance the food experience of consumers, especially those managing PDFLs.

Smartphones have access to information (generally referred to herein as attributes or metadata), such as historical context information about the transactions a consumer has engaged in via their smartphone and context information associated with the smartphone itself. Historical context information may include, for example, addresses of people the consumer corresponded with, the time when text/messaging exchanges took place between the consumer and consumers of other devices, dwell time at a specific tagged location (e.g., home or office) or untagged location (e.g., the waiting area at a specific corporate office or the line at an grocery store), health and wellness information, and key parameters regarding interactions with specific sites or apps (e.g., voice calls through meta-tagging, reverse lookups of the dialed number, web browsing or supported applications). Context information regarding the smartphone may include, for example, location, time, velocity, orientation, sound, lighting, extracted device parameters and application parameters, and may be gathered by the smartphone, other smartphones in its proximity, Beacons, Bluetooth, proximity oriented internet of things elements, servers connected to the Internet on a permanent or ad-hoc basis or a combination thereof. Context information associated with the smartphone may be stored on smartphone or servers.

Scanning through a camera or microphone is another key feature of smartphones, which may allow (among other things) the extraction of information from static sources, such as packages of food, or directing to content/web site through QR code. To be made relevant, the food information being presented should be made context-aware. U.S. Provisional Patent Application No. 61/583,432, which is hereby incorporated by reference as if fully set forth herein, describes making scanned information context-dependent.

Another important component of smartphones is local connectivity options such as Bluetooth and Wi-Fi, which may enable direct device to device communication and information exchange. This capability may avoid awkward questions when ordering food at a restaurant as medical conditions or conditions considered as medical do not have to be verbalized to staff. This provides challenges for privacy, something critical to many PDFL management.

The customization and control of the food experience can only take place if the consumer is engaged and controls the flow of information between different events implicitly (pre-authorized) and/or explicitly. The customization and control can only take place if the consumer profile is readily accessible and updated based on different food events explicitly and implicitly. This is especially true when dealing with PDFL.

To cater to PDFL consumers, participants in the food supply chain (such as, but not limited to, producers, farmers, CPGs, retailers, and restaurateurs) must provide additional information catered to specific special diets or allergies. Providing an extensive set of information must use precious space on pamphlet, menus, boxes and apps. Tailoring what to present to a specific consumer is an important factor in proactively participating in PDFL market places.

Described herein are methods, apparatus and systems for supporting control of profile driven food lifestyle information between suppliers of food products and events and consumers and achieving data integrity and privacy control to achieve diet and commercial goals. An apparatus supporting these methods may be an advanced Food Event Processing Platform (FEPP).

A FEPP may be implemented in many ways. For example, it may be one or more series of servers hosted by an internet provider (also known as cloud services). The hardware may be, for example, a personal device specifically designed for individuals to utilize for a given purpose, a general use device where the FEPP function is selectively operated by means of a special program on the hardware platform (e.g., a Personal computer running Windows or OSX operating systems or a portable phone running Android or iOS operating system), or a general access program such as an internet browser connecting to a website hosted on a remote computer. In general, they all use at least one computer processing device, memory for immediate processing of information, and memory for long term storage of information.

The FEPP, in order to provide the complex and diverse information and processing necessary for the implementation of the embodiments described herein, may have means to communicate with other computer processing and information storage platforms. Some of these may be other FEPP instances, while many will be ignorant of the existence of FEPPs.

The FEPP can be integrated with third party systems, such as databases or servers, in a manner that is transparent to consumers. This can be done through remote procedure calls or through application programming interface. Because of that, we treat FEPP and FEPP integrated with third party extensions or systems identically.

Also described herein are methods and apparatus for the processing of interactions between functions supporting profile driven food lifestyles. The apparatus supporting these methods is may also be the advanced FEPP.

Certain terminology is used in the following description for convenience only and is not limiting.

As used herein, “connected” means that elements within the system are connected physically or through a remote connection such that they are functionally connected. This connection can be temporary or permanent. As a non-limiting example, a remote connection may be through a localized radio frequency (RF) link.

As used herein, “teach” means an information linkage (e.g., data base, one function explicitly passing information to another, communication between diverse devices and/or locations), which allows transfer of information between various functions or components of a Food Event Processing Platform between two Food Event Processing Platforms. It is primarily, but not exclusively, used for machine learning.

As used herein, “scanning” means extracting information from an object from another device. Non-limited examples include using an optical camera, infrared, RF, radio frequency identification (RFID), QR code extraction, or microphone.

As used herein, “Food Event” (FE) refers to any activity related to food activities.

The words “grocery store”, “supermarket”, “store”, “commerce”, “commerce-site”, and “ecommerce” are used interchangeably unless stated otherwise. Stores can be brick and mortar stores or online (virtual and digital).

The words “restaurant”, “caterer”, “cafeteria”, “catering”, “public kitchen”, and “third party kitchen” are used interchangeably unless stated otherwise.

As used herein, “Food Event provider” (FEP) refers to any member of the food supply chain that supports one or more food events. It includes, but is not limited to, farmers, grocers, restaurateurs, CPGs, specialty product producers, distributors, and merchants.

The words “point of service”, POS, “cash register”, and “access points” are used interchangeably unless stated otherwise.

As used herein, “Food Event Provider Processing System” (FEPAS) is a system used by the Food Event Provider to interface with the consumer. It can be an integrated system or a distributed system with a front end unit connected to a back end server. It might be a mobile application running on a WRTU, which can be the same as the one used by a consumer or a different one. It might be a database, or an ontology library, accessed through an API. It might be a cash register or a point of sale. It might be a web site, mobile app, or a PC app. It might be a data structure, such as a token or a URL. It might be an RF beacon, a near field communication system, an audio beacon or an optical beacon. It might be an analog device, such as a printed material, QR code, menu, or packaging.

The words “function”, “micro-service”, “micro-service software component”, “software component”, “functional element”, “functional entity” are used interchangeably unless stated otherwise.

As used herein, recipes can be organized in recipe channels and recipe collections to facilitate management.

A recipe collection is a grouping of recipes managed by a consumer. The words “recipe collection” and “collection” are used interchangeably unless stated otherwise.

A Recipe Channel is a grouping of recipes done by a business partner of a FEPP (e.g., a retailer, publisher, blogger, group of bloggers such as FABLOGCON, or a Consumer Packaged Group). It can be set by a FEPP administrator. It is managed by one or more FEPP contributors. The words “recipe channel” and “channel” are used interchangeably unless stated otherwise.

Consumers can create recipe collections. Consumers can move recipes from collection to collection. Consumers can delete collections they have created. When consumers delete a collection, the recipes inside that collection may or may not be deleted. Consumers can create recipes, move recipes to and from collections, edit recipes, and delete recipes with some rules.

Coupons can be physical (paper, circular) or electronic (on PC, phone). The words “coupon” and “e-coupon” are used interchangeably.

Wireless receive/transmit units (WRTUs), such as cellular phones, have been used primarily to receive voice calls and to carry voice traffic and text (SMS) messages. Today, however, consumers use WRTUs to access information while on the go from a variety of different sources, such as the World Wide Web, application stores, and corporate resources. Smartphones, laptops, tablets, cameras, and sensors often include wide area 3G, 4G, LTE or other transceivers as well as Wi-Fi transceivers.

The words “extractor”, “extraction device”, “scanner”, “scanning device” and “extracting device” are used interchangeably unless stated otherwise.

All numbers expressing quantities of ingredients, goods, properties, and other parameters used in the specification and claims may be modified in all instances by the term “about.” Unless indicated to the contrary, the numerical parameters set forth in the following specification and attached claims are approximations that may vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

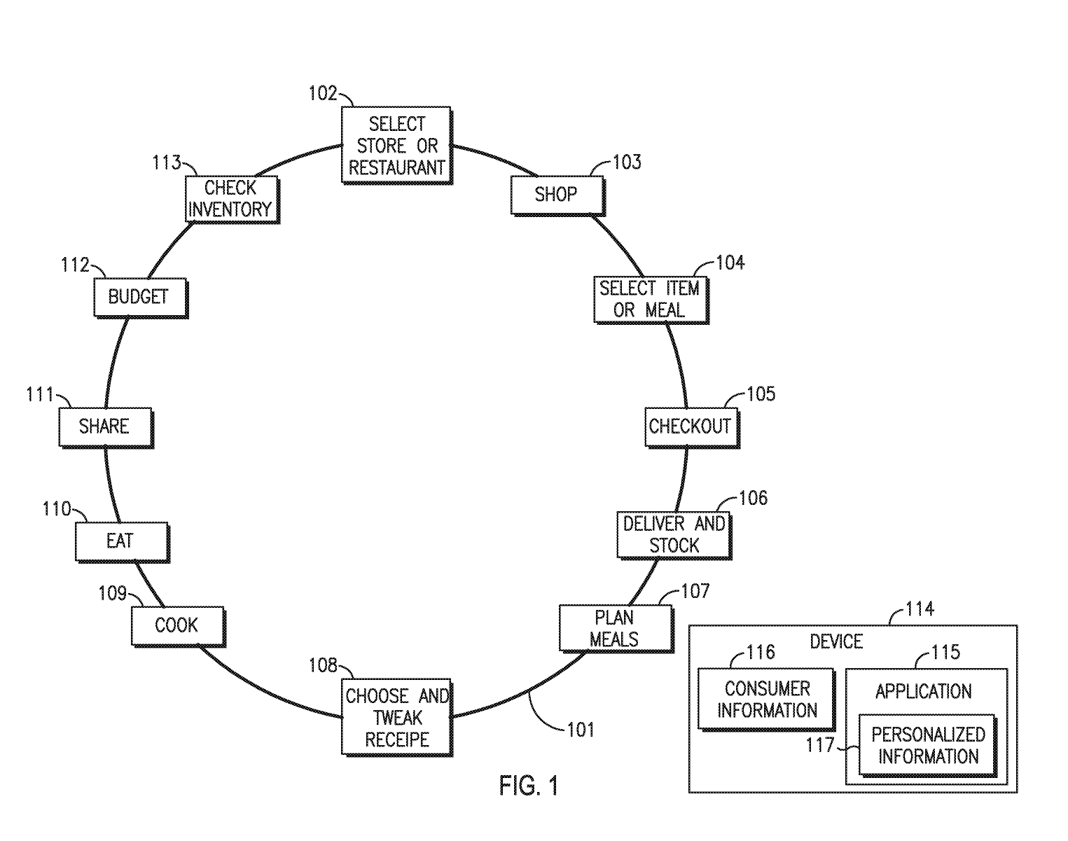

FIG. 1 is a diagram of a food cycle with constituent parts for procurement and consumption, and implication for the management of food related information by a Food Event Processing Platform (FEPP). The embodiment illustrated in FIG. 1 is a conceptual food cycle (101) used by the consumer and the Food Event Processing Platform. It includes, but is not limited to and does not assume a specific sequencing, food events, such selecting a store or restaurant (102), which may include online, shopping (103) (e.g., the examination of one or more items or services (e.g., delivery option)), selecting an item (104) (an essential moment for marketing), checking out (105), delivery and stocking (106), which involves physical interaction with food, planning meals (107), choosing and tweaking recipes (108), cooking (109), eating (110), alone or with others, sharing the experience (111), budgeting (112), and checking inventory (113). These are all exemplary instances of the steps that may be employed.

The device (114) illustrates the general form of the device the consumer utilizes in their exchange of information with the Food Event Processing Platform enabled by this invention. Typical devices may include, but not be limited to, Wireless Receive/Transmit Units (WRTUs), smartphones and specialized computers or tablets such as those made to enhance the shopping and eating experience. The specialized versions are usually simpler to use since they are targeted to a specific use, and, therefore, not burdened by extraneous hardware or software needed for other purposes. The device is running an application (115). Based on the consumer information (116) and the estimation of the food event that is located within the food cycle, the same conditions may trigger different information to be displayed and interactions (117) to be presented to the consumer. This information may be presented in whole or in part using text, audio, video, image, sound, vibration, notification, or combination thereof.

In an embodiment, the information presented to the consumer for a recipe, a food item or any other food related item or processing step may be different at different points on the food cycle. The position in the food cycle can be explicitly set by the consumer or implied from processing one or more external stimuli.

In one embodiment, machine learning may be used to evaluate at which point in the food cycle a food event is performed. Having this evaluation may be important, for instance, where interaction with the consumer might be important. Having this evaluation may be important, for instance, where scanning is used as part of the process. For instance, scanning can be used at a store (food cycle locations 103, 104, 105) and scanning can be used at home (food cycle locations 106, 107, 112, 113). Knowing, through geo-location, if the consumer is at home or away allows the ready determination of which cluster of the food cycle this interaction is most likely to be in. Rapid sequential scanning of food of the same type, such as soups, is likely the selection of soups to purchase (103) rather than finding a recipe that leverages said soup (107, 108). In the former case, nutrition information (or a coupon offer) is more appropriate to be presented. In the latter, recipe information is more appropriate. The consumer, of course, always has the option to override the conclusion presented by machine learning. Such an override may also be taken into account the next time a similar situation is determined to be in effect for a particular consumer or temporally taken into account if the consumer appears to be performing an exception to normal activity. The latter may be the case when shopping is occurring but the consumer wanted to examine a recipe to determine some information.

In another embodiment, scanning a menu in a restaurant with a smartphone may trigger the display of specific information on said smartphone. In another embodiment, scanning a menu in a restaurant with a smartphone may trigger the transmission of specific information to a designated device within said restaurant. Scanning at home should not trigger the same type of consumer involvement for profiling as at a store, market or restaurant.

In an embodiment, a mobile application running on a smartphone is used to present information on a selective basis based on its estimate of the position on the food cycle. While involved in each of the steps of procurement and consumption of food, the consumer may be presented with many forms of information when interfacing with the Food Event Processing Platform.

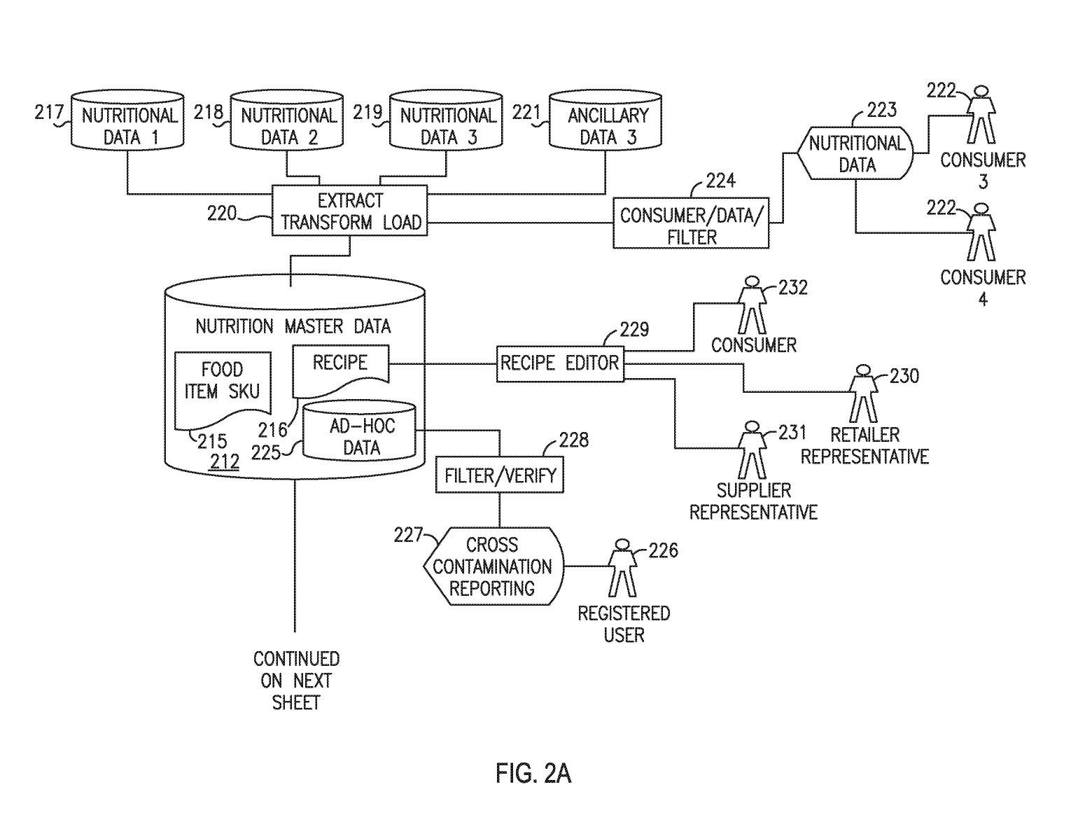

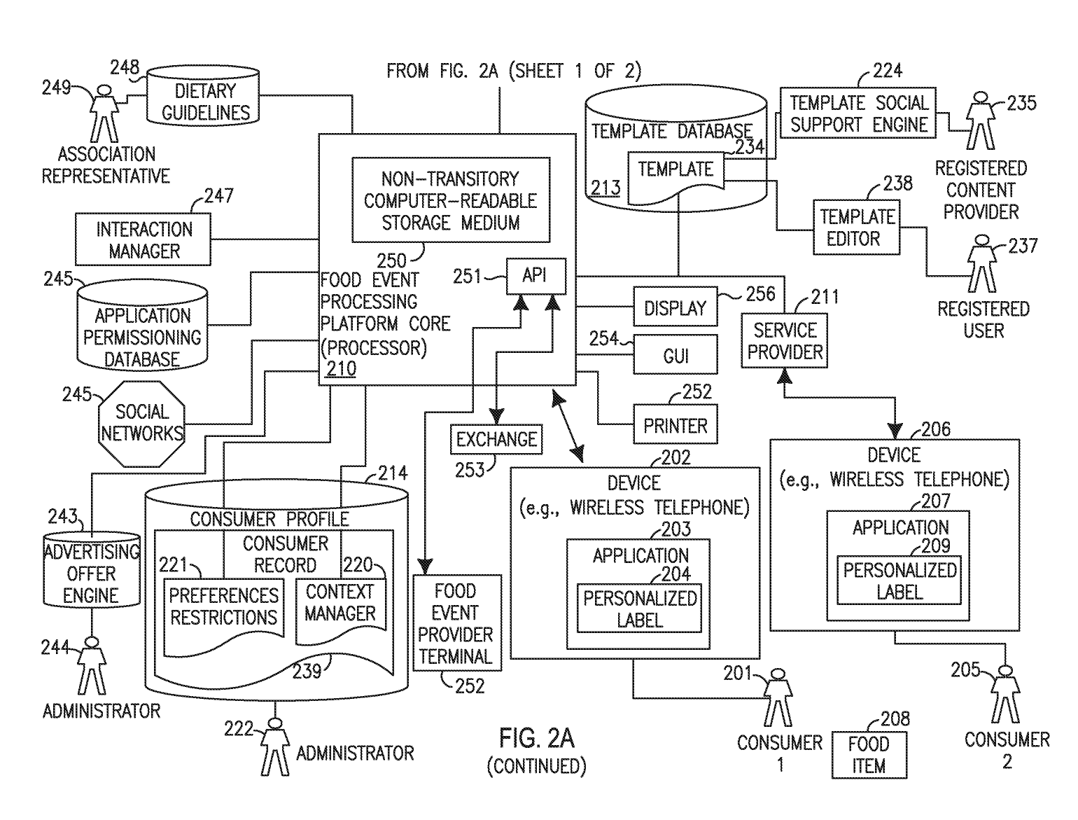

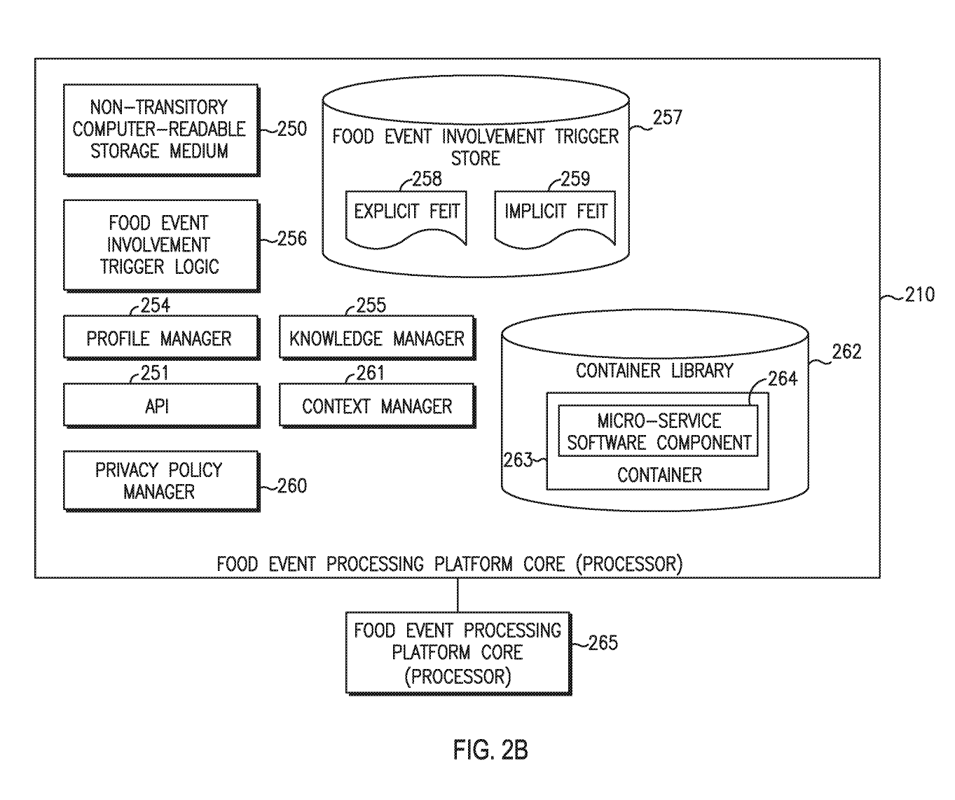

FIGS. 2a and 2b are diagrams showing the different users and components of a FEPP supporting need-based and profile-based food management services.

FIG. 2a shows information rich processing opportunities enabled by the embodiments described herein. In the embodiment illustrated in FIG. 2a, a consumer (201) is using a computing device (202), such as, but not limited to, a computer, a phone, a smartphone or a tablet, to run an application (203). This application may display at least one food label (204) that may be tailored to consumer needs, circumstances and interests. Another consumer (206) may be using another computing device (206) running an application (207) (the application 207 can be the same application as 203 but does not have to be). The application may be able to scan information associated with a food item (208) and display a personalized food label (209) associated with the consumer's needs, circumstances and the food item (208). Devices (202) and (206) may communicate with a Food Event Platform Processing Core (210) directly, or in the case of (206), through a service provider network (211). It should be noted that portable devices such as smartphone capture their location information as a course of normal operation. Location and time information may be used to establish or manage some of the consumer needs.

The Food Event Processing Platform Core may communicate with three principal components, namely, a nutrition master database (212), a template database (213) and a consumer profile database (214). The master database may allow retrieval of information based on a food item SKU (215) or recipe (216) among others. It can be implemented using any commercial or open source database management system product, including, but not limited to, PostgreSQL, MySQL, Mongo DB, and others. This database may include information from multiple nutritional databases, shown here as (217), (218) and (219). There are various ways to exchange information with the databases with the following being non-limiting examples: information from database 217 is accessed through an application-programming interface (API); Information from database 218 is accessed through an API; Information from database 219 is accessed via file transfer. The exchange may be purely a retrieval operation, or it may be a submission of information which induces some processing by the database followed by it providing determined information. To ensure the quality of the data, an extraction, transformation and load module (220) is selectively applied to the data. The first part of an ETL process involves extracting the data from the source databases. The transform stage applies a series of rules to the extracted nutritional data from the original database to derive the data for loading into the target database. The loading of the data is typically done on a scheduled basis based on the amount of new recipes or new items available in stores or dynamically synchronized with key events or processes. An ancillary database (221) can also be integrated. It contains elements not typically captured by a nutritional database such as, but not limited to, pictures and other multimedia content of ingredients, food items, videos, country of origin or production location. Traditional nutritional databases are corporate or governmental in nature, having been gathered from scanning information from packaging, regulatory filing, academic research and/or other publicly accessible information either freely available or under subscription.

Consumers (222) can provide additional nutritional information (223) such as, but not limited to, the presence of an allergen not mandated for government regulation, or the compliance of a food item with a religious code. To prevent corruption of the data, a filtering process is implemented (224) before the data is passed to the ETL processor.

Another source of information is ad-hoc information (225). This information is entered by a registered user (226). This registered user enters cross-contamination information (227) and other like information. It is first filtered (228) and stored in the ad-hoc data portion of the master database for use. Such information is often subject to review for correctness as it may be incorrect, incorrectly entered by the user, or from a malicious source. Until such a review occurs, it will be flagged in the database and any viewing or use by the user will be pending the review. The actual review may be by automated machine learning (ML) processing and/or human operators. The results may be reported to the user either automatically (e.g., by email), or when utilization associated with its instance next occurs. The review may allow unimpeded the use of the information, may block it, may request further clarification, may allow forced usage when appropriate (i.e., trusted and authenticated authority provided the input), or may flag it with statement as to its limitations.

Recipes (216) can be managed by authorized users through a recipe editor (229) by either a retailer's representative (230), a supplier's representative (231) or a consumer (232). The retailer or supplier can be restaurateurs.

The second key component of the system is the template database. It includes one or more templates (234). They can be static in nature, or interactive, and may include text, images, videos, audio files, software, or logic (among others). The templates can be created by registered content providers (235) using a template social support engine (236) or by registered users (237) using a generic template editor (238).

The consumer profile database (214) contains a set of consumer profile information (239) that captures information about consumer food preferences (e.g., type, timing of activities, shopping preferences, and eating preference) and restrictions (e.g., allergies and diets) (221). They can also include a context manager (220) that encodes heuristics and goals about consumer behavior. The consumer profile database may be administered by an administrator (244).

The Food Event Processing Platform Core can also be connected to an advertising or offer engine (243) administered by an administrator (244), an application/provisioning (245) database that controls which applications display which labels under what circumstances. Integration to socials networks (246) directly into the label or logic generating the labels is possible. The Food Event Processing Platform Core is connected to an interaction manager (247) that uses relevant attributes to link the different functions of the FEPP. A dietary guideline database (248) can also be integrated. Dietary guidelines can be edited by an association representative (249).

The Food Event Processing Platform Core (210) may include non-transitory computer readable storage medium (250) and may support an Application Programming interface (API) (251) that may allow interfacing with third party elements, such as a Food Event Provider (FEP) access point (252) or exchange system (253). By determining the event position of the consumer activity in the food cycle, the consumer, using the knowledge from previous food events, profiling and extended information from the sources shown in FIG. 2 may be used to tailor information presented to the consumer.

The Food Event Processing Platform can implement machine learning to aid the consumer in making decisions with their personal goals taken into account. This processing may be distributed physically at various physical entities, such as computer servers in the network cloud, personal computers, or portable appliances such as smartphones. Such goals may include nutritional requirements, monetary considerations, likes and dislikes, shopping convenience, general profile and just about any other consideration the consumer may want to teach each stage of the Food Cycle.

FIG. 2b provides more details on the Food Event Platform Core (250). A Profile Manager (254) manages profiling information about the consumer. A knowledge manager (255) implements key machine learning algorithms based on consumer profile (214). An integral component of the FEPP is an invitation for consumer to authorize transactions or other activities related to food events that links attributes associated with the food event to the profiling system or other element of the FEPP. These can happen synchronously to activities of the user/consumer. We refer to this invitation as a Food Event Involvement Trigger (FEIT). The FEIT may when the consumer engages with an activity on his/her smartphone or computer that involves a third party whether commercial or not. A FEIT can also be triggered when the machine learning algorithms using a FEPP require an explicit confirmation of a condition. An important class of FEIT is the exchange of consumer profile information between users or consumers. This is referred to as a Food Exchange Profile Exchange (FEPX). It should be noted that FEITs can be pre-set through defaulting that is preauthorized through settings. FEITs are managed through the Food Event Involvement Trigger Logic (256) and may be kept in a FEIT store (257). Some FEITs require explicit real-time processing by consumers and are dubbed Explicit FEITs (258). Others are configured once by the consumer and managed in the background without explicit real-time input. They are dubbed Implicit FEITs (259).

Any type of transaction or activity may be proposed, offered, or used by the knowledge manager. Any type of transaction or activity may be integrated, triggering or triggered by a FEIT. These transactions are commercial or non-commercial in nature, including, for example, matters related to advertising, lead generation, affiliate sale, classifieds, featured lists, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, interchange fee per transaction, fulfillment, licensing, data, user data, consumer data, user evaluations, consumer evaluations, business data, user intelligence, search data, real consumer intent data, benchmarking services, market research, push services, links to an app store, coupons, loyalty program, digital-to-physical, subscription, online education, crowdsourcing education, delivery, gift recommendation, coupons, loyalty programs, alerts, and coaching, recipe imports, ontology based searches, taxonomy based searches, location based searches, recipe management, curation, preparation time estimation, cooking time estimation, difficult estimation, meal planning, update to profiling, management of history, authorization for deep-linking, login in, signing up, login out, creating accounts, delete accounts, recipe modification by the consumers, software driven substitutions, database driven substitutions, substitutions based on allergens, substitutions based on nutrition, substitutions based on offers and incentives, substitutions based on time savings, inventory estimation based on superset approach, inventory estimation based on a priori and superset data, inventory estimation integrating direct queries, shopping list, shopping, shopping list management with integrated offers, distributed shopping lists, shopping based on recipes, automatic modification of shopping list, pre-population of elements in shopping list, context based modification of shopping list, shopping event with location or context based offer, shopping event with integrated interaction with point of sale system, tracking of expenses, sharing of recipe, restaurant reservation, rating, meal ordering, deep linking, games, gamification, trending food, recipes and events, presentation of incentives, presentation of recommendations, internal analytics, external analytics, single sign on with social networks.

To be efficient, the profiling engine and knowledge manager must absorb and manage information derived explicitly and implicitly from consumer and supplier (Food Event Provider) activities. This might be done within the context of privacy policies set by the different users of the FEPP. This management may be the task of the privacy policy manager (260). Context information may be managed in the context manager (261).

A FEPP supports a wide application of features supported by functional software components. They may include, for example, meal management (meal prepared inside home), shopping management, sharing of content and interactions, offer management, Restaurant Interaction Management (prepared outside home), and profiling. Micro services architectural style is one approach to developing an application in a FEPP as a suite of small services called Micro-Service Software Components, each running in its own process and communicating with lightweight mechanisms. These services may be built around function capabilities and may be independently deployable by fully automated deployment machinery. They are typically deployed in containers. Containers are light-weight runtime environments with many of the core components of a virtual machine and isolated services of an operating system designed to make packaging easy and execute these micro-services smoothly. The FEPP core holds a library (262) of containers (263) each with a Micro-Service Software Component (MSSC) (264). While this FEPP core is represented as a single entity, multiple FEPP cores (265) can be integrated or interconnected.

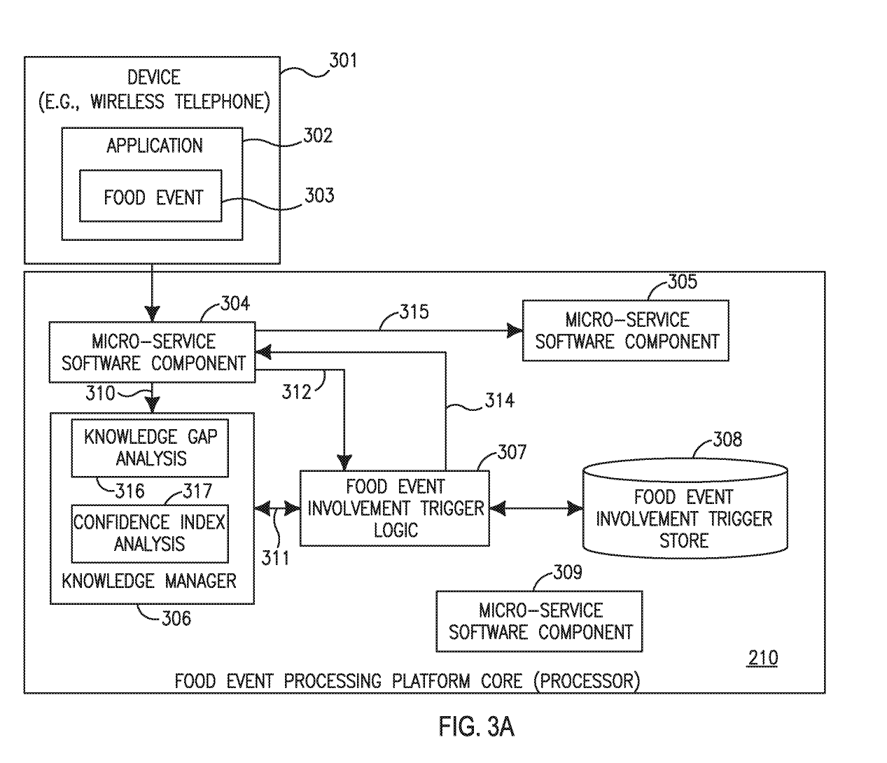

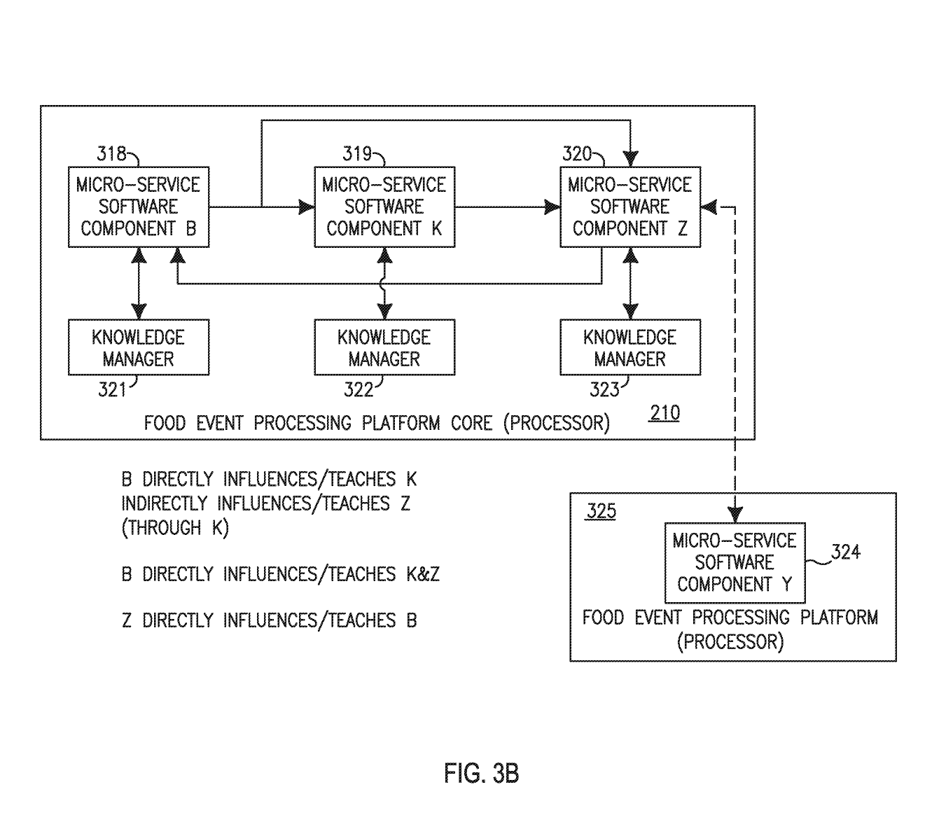

FIGS. 3A and 3B are diagrams showing the Food Event Involvement Trigger (FEIT) logic and knowledge manager supporting need-based and profile-based food management services. FIG. 3a and FIG. 3b provide details on the consumer-controlled linkage between FEPP functions supported by the FEPP core in FIG. 2b.

Referring to FIG. 3a, a WRTU (301) running a mobile application (302) processes a food event (303). The WRTU (301) interfaces with the FEPP core (210). The advent of smartphones allows capturing attributes and context related to food events. This information can be integrated in the communication between WRTU 301 and FEPP core 210.

The appropriate micro-service software component (MSSC) (304) may implement an appropriate software associated with the food event. Many MSSCs might be associated with the same event. To perform its required function, or after processing of the function, it might require communicating to another MSSC (305). This communication may, for example, be in the form of an API or placement of information in a permanent storage facility. A knowledge manager (306) manages and analyzes events and trends associated with consumers' and suppliers' activities as communicated with the FEPP. The knowledge manager, based on internal logic, might decide to involve the consumer (or other consumers) to provide explicit input or authorization. The management of such interactions may be performed by the FEIT logic (307) that maintains the FEIT store (308) in non-volatile memory. A typical flow may be that the MSSC 305 queries (310) the knowledge manager and queries (312) the FEIT logic. Based on its knowledge, the knowledge manager might affect (311) how the FEIT, after querying (313) the FEIT store, responds (314) to the query (312) from the MSSC. The information or teaching may be passed to the MSSC 305. The selection of the MSSC 305 might be determined by the knowledge manager 306 and/or FEIT logic 307 working together or separately.

A key element of machine learning is managing knowledge gap thresholds (316) and confidence indices (317) related to a specific area of knowledge. They can drive how and when the knowledge manager interfaces with the FEIT logic.

Examples of confidence indices include the probability of being correct, anti-probability of being wrong, Point wise Mutual Information (PMI), and entropy measures. These confidence indexes can be used to determine when to seek explicit information from the consumer in the form of an explicit FEIT. This FEIT can be combined with other FEIT such as liking and disliking of ingredients or products. In one embodiment, the FEPP maintains a series of ongoing and/or outstanding knowledge gap measures. Whenever this knowledge gap exceeds one or more threshold, a FEIT or set of FEITs is generated and interacted with the consumer through some form of user interface.

The knowledge gap thresholds can be set to different values based on explicit settings or implicit information. A consumer may explicitly set the threshold by a numeric value, for instance by using a range of 0 to 100 percent confidence scale, where 0 means no confidence in implicit calculations and the consumer should always be given the opportunity to set the knowledge gap. 100 percent means the consumer trusts the threshold derivation from implicit information, and, therefore, should not be requested to provide an input. A value set between these extremes can be set, which then requires a calculation procedure to determine the threshold to be used. Alternatively, to setting numeric values directly, a consumer can be provided with language modifiers, such as used in Fuzzy Logic. Modify terms such as ‘no”, ‘some’, ‘high’, and ‘complete’ before ‘confidence are selectable by the consumer, but translated by the programming to numeric values such as the numeric scale previously mentioned (e.g. no→0, some→0.3, high→0.7, complete=1). Another approach is visual, which, for instance, may include a slider being presented to the consumer. Moving the slide between the extreme values sets a proportional numerical value for the underlying programming to utilize.

The knowledge gap can be set to reduce the accuracy of estimating key attributes to less than present accuracy measurements. Measures of accuracy include, but are not limited to: Error measurement (mean, mean squared, bias, variance, standard deviation, higher moments, probability of error, probability of false detection, probability of missed negative) or uncertainty measurement (mutual information, entropy, relative entropy, Levensthtein distance, negentropy, Kolmogorov distance).

The knowledge gap thresholds can vary based on the number and nature of the food events experienced by the WRTU.

There are various ways to determine threshold values for implicitly determined terms. Linear Regression, Analysis of Variance, Pearson Correlation, and T-Test are some such means often utilized.

The (dynamically) connected MSSCs can be analogized to providing the functional “bearer” services of the FEPP. One can think of the knowledge manager and Food Event Involvement Trigger infrastructure as the “signaling channel” for machine learning and profiling, akin to the signaling control of communication systems found in ISDN or 3G/4G/3G.

One advantage of the architecture illustrated in FIG. 2 and FIG. 3a is that it allows for extensions to everyday operations to be integrated without overwhelming the consumer with continuous go/no go interactions. Another advantage to the architecture is that it may allow for independent scaling of the FEPP between core services and machine learning, knowledge management and personalization.

FEPP machine learning is the discovery and communication of meaningful patterns or exception conditions in data related to the food activities of consumers on the FEPP in the aggregate or individually. It is supported by the knowledge manager (or set of knowledge managers) and FEITs. It supports unsupervised learning, supervised learning, and assisted learning. Assisted learning is a key feature enabled by FEITs. There are benefits to consumers (a non-limited example is finding what a consumers spends their time on), operators (a non-limited example is finding which product is more often requested in substitution when the recipe substitution is done at 6 PM), curators (a non-limited example is finding the ingredients that are most often searched for in exotic versions/options), CPGs (a non-limited example is finding which product from a competitor a user is most likely to replace), retailers (a non-limited example is finding which long tail product brings a consumer to drive to a particular store), restaurants (reduction of inventory, extended clientele), online retailers (a non-limited example is finding at what time and under what conditions a retailer is selling gluten free products the best). In one embodiment, the FEPP uses one or more of predictive analytics, enterprise decision management, retail analytics, store assortment and stock-keeping unit optimization, marketing optimization and marketing mix modeling, web analytics, price and promotion modeling, predictive science, credit risk analysis, and fraud analytics to provide analytics.

The involvement of a consumer through FEITs can be solicited in various forms, time periods, and at various associations with the state of the consumer with regard to the food cycle illustrated in FIG. 1.

If the consumer is in a low threshold mode for a food event, any such change may cause an immediate request for necessary additional information. Such information could be a confirmation or rejection of a program determined entry or a sequence of questions that guide the consumer to provide missing information. If the consumer is in an intermediate situation, the request for involvement could be placed in a queue for later presentation to the consumer. The request for involvement could be made known to the consumer by means of varying intrusiveness. For instance, an audio alert could be generated with a sound associated with the degree of importance for consumer involvement. An existence indication could be made visually available to the consumer in one or more of the approaches the operating system or program in use normally provides (e.g., a status bar and information windows adjacent to use work windows). Numeric values could be associated with the alerts to indicate how many distinct consumer interactions are pending. Alert text formatting and associated alert images can be adjusted depending on the importance and/or count of pending consumer interactions. A threshold may be set such that exceeding it will cause an escalation of the consumer involvement solicitation.

In some circumstances, the consumer whose FEIT is needed to resolve an issue may not be the consumer initiating the change prompting the involvement. The involvement issue may, therefore, be added to the resolution queue of the consumer or consumers who are appropriate to handling the issue. Multiple consumers may need to be involved depending on the nature of the issue and its propagation to other processing points as generally outlined in FIG. 3a and FIG. 3b.

The triggering of a FEIT may be dependent upon the consumer's location. For instance, this may be a convenience consideration, or one of security in regards to exposing the information to possible access by others. The location may be determined by physical location identification via GPS, or wireless signaling devices with restricted communication ranges, such as Wi-Fi access points. The consumer may at any time examine the queues of pending FEIT requests and initiate selective ones as deemed appropriate.

The triggering of a FEIT may be dependent upon the context and history of consumer activities. The triggering of a FEIT may be dependent upon the context and history of supplier activities.

Another advantage of the architecture illustrated in FIG. 2 and FIG. 3. is that it may allow for the transfer of attributes from food events for machine learning and profiling that respects the engagement rules set by food event providers.

FIG. 3b illustrates how communication and knowledge can propagate across micro-service software components that can have inputs from other micro-service software components whose interactions teach all or some of results output from the micro-service software component. These teachings likewise propagate to other functions either by direct exchanges of data, modification of databases, or inquiries to the entities that store or have access to storage of the databases, or indirectly by intervening functions when a change at the beginning of a chain of data exchanging functions propagates through the overall chain.

It should also be noted that it is possible to have multiple instances of the same micro-service software components, albeit with different supporting data sets. For instance, one function may be supporting restaurant X, while the same function may be supporting recipe PLATFORM CORE at home. This would be the case for recipe modification as the ingredients on hand for restaurants and immediate substitution might be much more limited than the ingredients on hands at home since some of them can be purchased ahead of their use.

FIG. 3 illustrates how communication and knowledge can propagate within a FEPP. In this case, direct, indirect and feedback knowledge are illustrated. Functions (aka MSSC) (318, 319, 320) may be implemented in the FEPP core (210). Each MSSC is associated with a knowledge manager (321, 322, 323). In this representation, a knowledge manager is associated with each MSSC. An alternate (not shown) approach would be to have a common knowledge manager associated with two or more MSSCs.

A direct teaching would be the connection or communication (319) from B to K and B to Z paths. This example illustrates the case of an indirect teaching, in that MSSC B (318) teaches MSSC K (319), and this knowledge propagates from MSSC K (319) to MSSC Z (320).

When there are loops among MSSCs and their interactions, a simple propagation to a conclusion may not be possible. An example of such a loop would be a diet based function. An initial recipe is chosen by MSSC B (318), and it is transformed by MSSC K (319) for compliance with allergies and nutrition goals. The impact of the recipe on the weekly calorie intake is done by MSSC Z as part of a diary function. If the recipe is likely to make the consumer fail her goal, then a new recipe must be chosen by K. Referring to FIG. 3b as an example, MSSC B (318) teaches MSSC K (322) and MSSC Z (320), and MSSC Z (320) in turn teaches (308) B (303). Since B (318) is now different, the data must once again propagate through the loop. Depending on the nature of the functions, there are several approaches to knowing when to stop. One is to treat the data as an optimization problem and use an approach such as the simplex method. In this approach, a set of goals is established and a set of equations relating the various options is created. The Simplex method then searches for the allocation of resources that optimizes the goals.

A more general approach is to iterate through the loop of MSSCs, examining the results at the end of each loop. If all the results fall within an acceptable range, the process can stop, and the values may be determined at that point utilized. Alternately, it is possible that the results merely oscillate with one or more parameters, never falling within a deemed acceptable range, or that improvement in goals is not significant enough to justify continuing the search. These situations should to be detected, and the processing should be terminated when they are detected. In such cases, the situation should be identified to the proper entity. Said entity may report the situation to a human operator, or, under some set rules, change the data being used by the processing and try running the processing again.

An example would be to present supplementary information about an ingredient to a consumer while they shop for that ingredient. If, for example, the information about chipotle has been shown to the consumer 3 times, there is no need to show this information again. If a consumer wants meal information from a local fast food restaurant to be counted as part of her regular diet, and that restaurant is part of a chain, then the recording should be authorized for all restaurants of the same chain.

Another advantage of the architecture illustrated in FIG. 2, FIG. 3a and FIG. 3b is that it may allow for management of privacy (e.g., from consumer to food event provider) and tailoring of food event attributes (e.g., from food event provider to consumer).

This is illustrated by the optional connection between the MSSC Z and MSSC (324) hosted by a 3^{rd} party Food Event Provider Platform (325). In this case, MSSC Z might manage the privacy policy of the consumer (which includes access to its profile), and MSSC Y may contain relevant information about the Food Event (e.g., menu).

The functions supported by the FEPP are organized by functional groups and sub functions; namely meal management, shopping management, sharing of content and interactions, offer management, Restaurant Interaction Management, and profile management. This organization may be for the purpose of classification, and it may be considered as conveying a specific software architecture, data base schema or ontology library.

The key goal to meal management is to present appropriate meals based on circumstances. This may require access to a large number of recipes (for home preparation), restaurants and kitchens' menus (for outside the home meals), organizing them not only according to cuisine and meals, but using functionalization of the food components, taxonomy of ingredients, taxonomy of recipes and analysis from the practice of the recipes, location, cost, general availability, among others.

Recipes can be clipped from a web site into the FEPP. In one embodiment, the FEPP clipper can be a plugin to a browser allowing the consumer to select the recipe while browsing on a PC, phone or tablet. In another embodiment, the clipper can be an extension of a cooking application. In another embodiment, the clipper can be a mailbox assigned to a specific consumer when the consumer e-mails a link and/or the content of web page for processing. In an embodiment, the clipper provides feedback to the consumer about the status of the processing of the recipe. The same ingredients can be found in many recipes under different spellings, regional or ethnic names, with and without typos. Ingredients may need to be clustered and organized around normalized or stem ingredients. In another embodiment, fuzzy matching (letters in different places) may be used to determine if a new ingredient (one not associated with a normal ingredient) should be matched/paired/clustered to a normal ingredient or if a new normal ingredient needs to be created.

Food events and food event providers can be searched based on keywords or context through standalone or integrated search engines. They can be organized and classified for machine learning purposes using distance measures or metrics based on attributes. In one embodiment, the distance measure is a Euclidian distance. In another embodiment, it is one out of p-norm distance, Chebyshev distance, Hamming distance, or Mahalonobis distance. Similarity measures can also be used to lump recipes together. In another embodiment, the cosine similarity or Point Wise Mutual Information is used. The mapping of attributes as locations determines the impact of these distance measures. Some of these attributes can be quantitative. In one embodiment, the attributes are taken to be one or more out of the USDA SR27 nutritional attributes. Some of the attributes can be qualitative. In one embodiment, the presence of normalized ingredients from a database is used as location information. In one embodiment, attributes are catalogued on whether they provide a specific functionality.

Adapting meals (whether cooked at home or outside home) may be an essential aspect of managing PDFLs. A form of distance may be graph-based, where numbers and types of substitutions are required to go from one recipe to another. In one embodiment, the number of consumer initiated changes is used as a distance measure. In another embodiment, multiple transformations paths (e.g., from recipe A to recipe B to recipe C to recipe D and from recipe A to recipe E to recipe D) are combined (e.g., using an averaging method) to provide this distance measure.

Recipe creation and modification may be an important function of a FEPP. In one embodiment, a consumer may be able to enter a recipe in free form text or using a form based input system. In another embodiment, the selection of ingredients may be based on selecting pre-set tokens (e.g., to facilitate later search). These tokens can be encoded using (in a non-limiting manner) JSON, XML, and SQL. The tokens can be kept on the same server, smartphone or system the consumer is using to access the FEPP or on a remote system. In another embodiment, tokens are used to represent cooking steps, cooking methods, instruments and results. In another embodiment, the consumer provides audio, video or pictures of cooking and eating processes. In another embodiment, tokens are encoded from consumer-entered text via machine learning to associate them with existing ingredients, cooking steps, cooking methods, instruments and results in the FEPP, resulting either in links to stem recipes, cooking steps, ingredients, cooking methods, instruments, or in new stem recipes or tokens.

To support commerce, extensions to food events should be integrated with the FEPP. However, to not overwhelm consumers with too much information when not appropriate (this is especially important when the consumer interface is a limited screen size smartphone), channels or food activities can be integrated in the FEPP. One way to achieve this goal is to provide a restricted web page that can be edited and contextualized by multiple editors and whose appearance is triggered by logic. We refer to this type of page as a billboard page. These pages can be implemented using any web content management system (e.g., WordPress and Drupal). In another embodiment, the billboard pages may be mapped to a specific consumers based on their login information, account information, cookie or device identifier. In another embodiment, the content of the billboard page may be changed by the FEPP based on consumer behavior, FEITs, other consumers' behaviors, time, location and historical data.

In another embodiment, ingredients may be associated with commercial food products to allow for commercial promotion. In another embodiment, ingredients may be associated with allergen contents, and a recipe allergen content may be computed. In another embodiment, consumers may be associated with kitchens, collecting family, friends, housemates and others who share a cooking space. In another embodiment, consumers may be associated with virtual kitchens, collecting consumers who share recipe, ideas, and cooking experiences together via electronic means. In another embodiment, consumers and kitchens may be associated with recipes they have created, cooked, served, rated, or found via query. In another embodiment, ingredient products may be associated with retail stores, manufacturers, grocery stores, and other business establishments. In another embodiment, recipes, consumers and kitchens may be associated with meal events, capturing information about the event, the recipes cooked and served, and the enjoyment level of the participants. In another embodiment, recipes may be associated with recipe boxes, which may, in turn, be associated with consumers or kitchens. In another embodiment, recipe boxes may be associated with virtual kitchens, allowing them to facilitate shared cooking experiences in ways not limited to family ties, friendships, physical space, time and geography. In another embodiment, recipes may be associated with channels, which may, in turn, be associated with retail stores, manufacturers, grocery stores, and other business establishments. In another embodiment, ingredients and products may be associated with coupons or other promotions, which may, in turn, be associated with retail stores, manufacturers, grocery stores, and other business establishments. In another embodiment, recipes may be associated with cuisines, types of dish, categories in a cookbook, or other organizational taxonomies. In another embodiment, consumers may be associated with food restrictions, including allergies and other medical restrictions, self-imposed diets, and food preferences.

In another embodiment, tags (such as labels, tags, hashtags, annotations, and other similar content) may be associated with recipes, ingredients, recipe steps, cooking methods, instruments, stem recipes, tokens and other elements of the FEPP. In such an embodiment, tags may represent an organically developed taxonomy based on consumer input (“folksonomy”) and may have some elements that are hierarchical in nature, others that are associative in nature, and still others that may be best represented in the form of a directed or undirected, unimodal or multimodal graph (in the mathematical, nodes and edges, sense). The reputation management function described herein may be used to weight the importance to give to specific inputs.

A shopping event may be referred to herein as the action of doing a specific purchase. A shopping event may involve at least a shopper, a location, a time and date and an item.

In one embodiment, ingredients from recipes selected by a consumer may be selectively or collectively copied to a shopping list maintained by the FEPP. Because multiple consumers may be using the same recipes and can be organized into demographic segments, and since shopping patterns are somewhat repetitive and similar (e.g., many families in the same geographic area shop at the same store), the FEPP can analyze the shopping patterns (e.g., shopping list, shopping events, location and time) and prepopulate part of the shopping lists for the consumers.

In one embodiment, the shopping list of the consumer may be prepopulated based in part on the estimate of what is in her inventory (e.g., pantry and refrigerator), patterns of use, expiration times, and use by period for her home and data from other consumers. In another embodiment, the pre-population may be done based on a confidence index managed by a knowledge manager inside the FEPP supporting the consumer activities.

In a manner akin to task management, the consumer may enter a preferred weekly list to verify the purchase and scan the receipt from the store she bought the items at during or after a shopping event. This is a form of very explicit knowledge input. In another embodiment, an electronic receipt (such as web page or email) may be forwarded to the FEPP for processing. In another embodiment, the information may be automatically provided by the retailer as a condition for participation in one or more functions of the FEPP.

In one embodiment, the shopping list may be broadcast in part or in total to members of the same families or members of a FEPP account. In another embodiment, the broadcast may be performed based on time of day, day of week, or previous shopping events.

In another embodiment, the shopping list may be emptied in part and in whole by the consumer when she shops.

In another embodiment, the consumer may authorize access to her shopping list to retailers based at least in part on location and time and recommend changes to the shopping list. In another embodiment, the consumer may authorize access to her shopping list to retailers and suppliers based at least in part on the original recipes searched, favorited or selected, or recommend changes to the shopping list. In another embodiment, authorized third parties may provide changes to the shopping lists based not only on ingredients but also on recipes searched, favorited or selected by consumers.

Taking advantage of the repetitive and cyclical nature of shopping, the FEPP can prepopulate specific items in the shopping list. In one embodiment, the FEPP prepopulates a consumer shopping list based at least in part on previous purchases or a-priori items that are most popular or least associated with a specific set of preferences (for instance if the consumer indicates liking Chinese cuisine, rice is added on a more regular basis, if she indicates vegan, meat is never added).

Menu planning may allow for goal setting and time management along with saving money. Menu planning can be challenging because it requires the selection of the food to be managed by way of food selection, cooking needs, purchase, and time constraints. Another challenge is the discipline needed to make it effective. Menu planning allows for efficiency in the kitchen and reduces food waste and unplanned trips to buy groceries along with integration of nutritional means.

In one embodiment, menu planning consists of reconciliation of menu selections, with the integration of favorite or frequently used recipes that have been tried and deemed successful for the family or individual consumers. Selection of recipes can be obtained from existing recipe collections within collected and aggregated lists or from other sources to include digital recipes from websites, mobile apps, eBook devices or searches through search engines. In another embodiment, menu planning allows for dietary management, such as calorie intake and other markers, with an emphasis on lifestyle needs and goals. Selections can incorporate special dietary needs, such food allergies, food intolerances, vegan, paleo, diabetes weight management, other medical needs and all types of PDFLs.

In another embodiment, recommendations for meals may be created based on activities in other parts of the FEPP. In another embodiment, recommendations for restaurants may be created based on activities in other parts of the FEPP.

In another embodiment, menu planning may allow for shopping list creation allowing for inventory management, integrations based on what a consumer needs and what a consumer customarily buys along with other food routines that meet lifestyle needs. Menu planning reinforces saving time and money. Menu planning can be reinforced with community curation with other home cooks with similar tastes and special diets to share and explore new foods. This time management process will even allow long term planning and integration with tools such as calendars on electronic devices. Menu planning can be part of gamification concepts and practices with rewarding based on meeting goals related to time, money, and less food waste along with dietary practices. Gamification can also include recipe collections that incorporate new time and tested practices along with family or community approved meals.

The food diary may allow for management and acknowledgment of food choices. In one embodiment, the food diary can measure calorie consumption and tracking of food consumption along with weight management. Food diaries can facilitate changes in food behavior with the acknowledgment along with awareness of food intake. In another embodiment, the food diary is overlaid with a measure of the impact of ingredient substitution (taken or potential to take) to guide the consumer toward healthier choices.

Not all food events have to be considered for inclusion on a diary. In one embodiment, a FEIT is used to control whether or not information should be included in diary. This FEIT may impact the knowledge absorbed and propagated through the FEPP.

Individual sharing can be used when privacy consent has been secured as personally identifiable information (PII). Global sharing is anonymous in most instances.

There are multiple ways to link activities across the FEPP. One set of methods relies on linking the cooking of a recipe to the originator of a recipe through a recipe ID. Another relies on linking the variations (e.g., modifications of recipes) to the original recipe ID. In another embodiment, a tweet or link back to the web page of the original recipe is generated as the recipe travels through the FEPP.

Another embodiment uses deep-linking across elements of the FEPP or applications enabled by the FEPP. In one embodiment, deep linking is done using a hyperlink that links to a specific piece of content within an application or the FEPP. The specific content could be a specific view, a particular section of a page, or a certain tab.

In another embodiment, sharing may be done by performing trend analysis of key FEPP uses.

Games and gamification can be a very powerful tool to get consumers to participate in using and sharing as well as in the curation experience. In one embodiment, the FEPP provides data representing a computer game scenario to a consumer device for display on a consumer interface of the consumer device for game play, wherein the computer game scenario on the consumer device prompts a game player to perform an activity including using a specific ingredient in a recipe, providing a picture of the specific ingredient, buying a specific product, going to a specific store, using a specific offer, and cooking a specific recipe. Collecting real-world food activity data generated during performance of the activity, the collected real-world food data might include a brand of a specific product; and using the collected real-world food activities data to update, add to, or supplement a FEPP database remote from the consumer device.

In another embodiment, the FEPP collects generic and individual food and food activity data for a FEPP database using computer game play using a method comprising identifying the need for food or food activities data in the FEPP database, determining an activity to be performed by a computer game player to collect the food or food activities data lacking in the navigation database, the activity including a real-world activity formulating a game scenario of a computer game that prompts the computer game player to perform the activity; providing data representing the game scenario to a consumer device, the game scenario displayed on a consumer interface of the consumer device in which the computer game is being played on by the computer game player; collecting real-world food or food activities data based on performance of the activity, the collected real-world food or food activities data corresponding to the identified lack of food or food activity data in the FEPP database and including data indicative of point of interest; and updating the FEPP database based on the collected real-world food or food activity data, the updating including the point of interest where the point of interest is one of more of diet restrictions, food restrictions, ingredient restrictions, additive restrictions, diet framework, diet plan, food selection restrictions, food preferences, cross-contamination information, cross-contamination feedback, budgetary guidelines, loyally programs, serendipity guidelines, interaction with expert, referral generation, referral management, package scanning, picture taking, audio recording, video recording, item scanning, nutrient checking, caloric ratio estimation, estimated glycemic load/index computation, search for recipe, modification of recipe, response to query from food providers, response to query from food service management services provider, advice from independent agents, advice from agents affiliated with food management service provider, advice from agents registered with food management service provider, expiration of timer, date of food activities, reading of referrals, generation of referrals, location of food activities, food ratings, rating of recipes, rating of food activities, inventory management, shopping list management, shopping.

In another embodiment, consumers may interact with restaurateurs to improve their choices of food while dining. In one embodiment, profile information is automatically shared with restaurant as consumers walk in and only the relevant menu or dishes are in return proposed to the consumer.

In another embodiment, consumers are encouraged to share their involvement and the significance of it to the overall community. This can be manifested by assigning titles of increasing ranking to consumers and/or their content. The more interaction they have in support of the needs of the FEPP, the higher the ratings or count of positive indications they receive and/or the more their input is solicited or the more likely they are to receive recognition. This type of positive feedback can be assigned numerical values. The consumer is, therefore, in competition with others to improve their standing in the community.

Within the Offers Management Group, the basic sub-functions may be Incentive Management and Replacement Presentation Logic. The production of incentives to the consumer can be done at food events.

Through the inclusion of third-party partners, a consumer can specify where they will be purchasing their items. This can be accomplished through the use of the mobile device's GPS functionality, whereby the application can display a list of all of the partner vendors in the area. The consumer will then select the appropriate vendor. Once this information has been provided, a list of available offers and incentives will be delivered to the consumer. Additionally, the returned list of offers can be further refined based on each individual consumer's preferences and special nutritional requirements. These offers can be made available to consumers whether they are shopping through an online retailer, restaurant, or a traditional brick-and-mortar establishment. Offers can also be presented based on the purchasing trends of individuals with similar preferences and dietary needs. The application's sharing feature can also be incorporated, allowing for offers to be presented based on those utilized by others on the consumer's list of friends and family. The consumer can also tag and share offers that they feel would be of value to others on their list of friends and family.

The different actors involved in the FEPP (e.g., consumers, restaurateurs, CPGs, and retailers) can impose rules (heuristics) on how to present specific incentives during the presentation of ingredient replacement. These heuristics can be the results of commercial contracts. In one embodiment, these rules are encoded in the FEPP. Based on the explicit and implicit knowledge of the consumer in the FEPP, the value of a presentation of an ingredient may be computed from the perspective of the FEPP operator, the consumer, the retailers and brands. Those valuations may then be optimized in a presentation engine to balance competing interests.

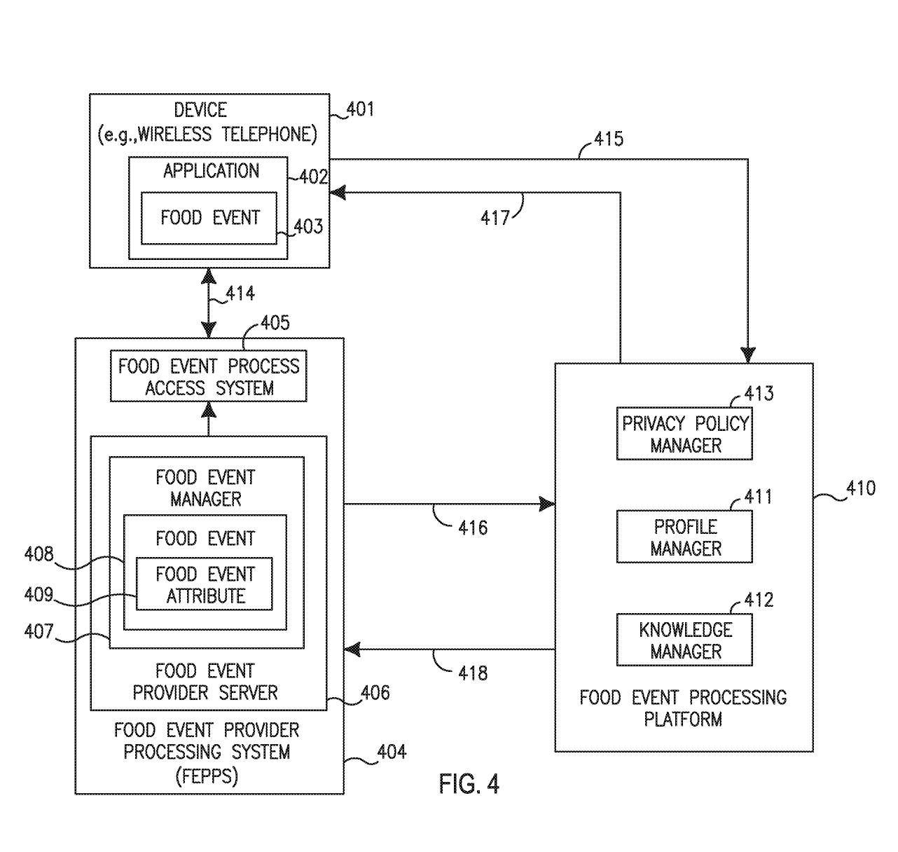

FIG. 4 is a diagram of an example FEPP that may provide anonymized profile information directed by a Wireless Receive/Transmit Unit (WRTU) such as a smartphone. FIG. 4 illustrates how the FEPP can be used to reduce friction between a consumer and a food event provider and share information according to respective policies. A WRTU (401) is hosting a mobile application (402) to process a food event (403) when interacting with a Food Event Provider Processing System (FEPPS) (404). This FEPPS has a local Food Event Process Access System (405), which may be at the Food Event Provider location where the consumer is (with her WRTU). The Food Event Process Access System may interface with a Food Event Process Server (406) that hosts the food event manager (407), which is where rules and logics for information processing, information exchange privacy are managed. The food event manager may store food events (408). Each food event has attributes (409). These attributes can be static or dynamically created. They can include context information. They might require information about the WRTU owners whose attributes can be used to process food events. Different attributes can be used in different manners for different food events supported by the same WRTU, such as purchase at a grocery store A, scanning at a grocery store B, and ordering at a caterer C. For the same food event (e.g., ordering at restaurant D), different attributes may be used (e.g., for a WRTU of consumer F who has a loyalty program vs a WRTU of a consumer E who has not). The consumer's FEPP (410) may be involved in the food even transaction. It holds the Profile Manager (411) and knowledge manager (412) (other elements are not shown). The interaction flow may be as follows. The WRTU and the FEPPS may be made aware of each other through a communication request (414). This can be initiated by either entity. The WRTU exchanges message(s) (415) with the FEPP, and the FEPPS exchanges message(s) (416) with the FEPP. The FEPP exchanges message(s) (417) back to the WTRU. The FEPP exchanges message(s) (418) back with the FEPPS. The sequence and content of messages (415, 416, 417, 418) varies based on the implementation of specific food event processing.

The exchange of profile information to affect food event attributes and food event attributes to affect profiling is a key feature of the FEPP architecture described herein. It allows the tailoring of the precise portion of a consumer profile that needs to be exchanged to support, and only that portion needed. This may avoid sharing unnecessary information with the food event provider and may allow anonymized exchanges of information about consumer profile and food event attributes. The flow diagrams that follow provide example methods for profile information exchange.

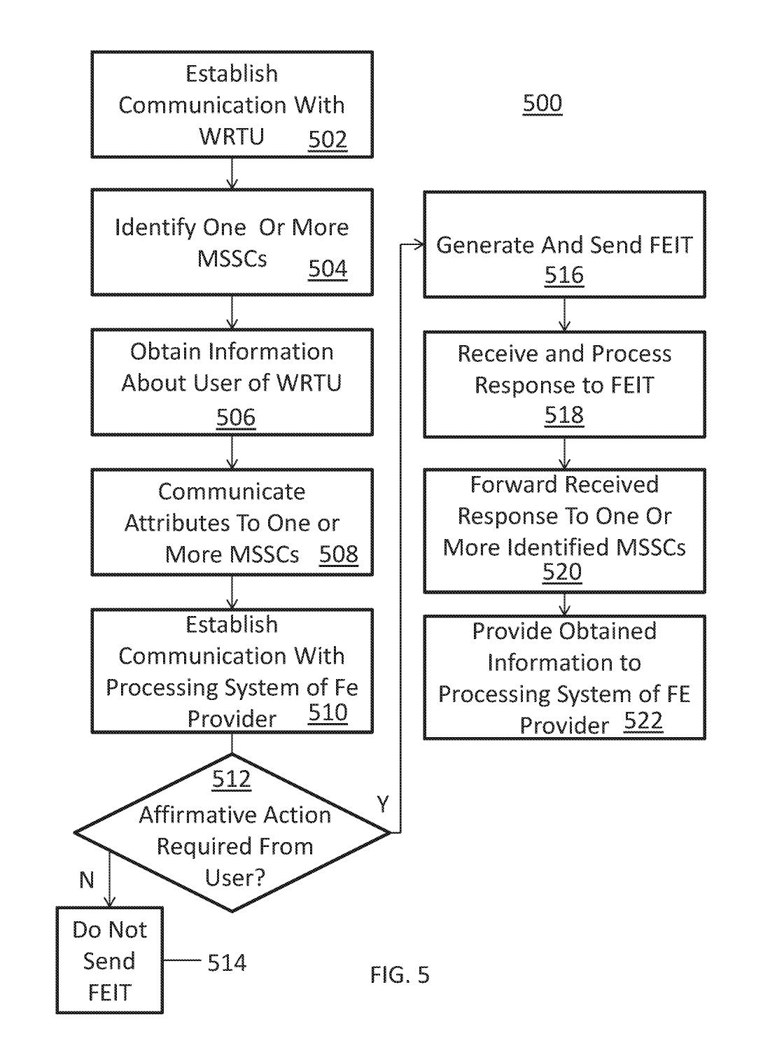

FIG. 5 is a flow diagram 500 of an example method for consumer profiling in support of food-related activities. In the example method 500 illustrated in FIG. 5, communication is established with a WRTU (502). Referring to the system diagram of FIG. 4, for example, the FEPP 410, which includes a profiling manager 412, may establish communication with a WRTU (e.g., device 401) that is attempting to process a food-related event (FE) 403. The FE 403 could be initiated by the WRTU, for example, when a user uses the WRTU 401 to scan a menu in an attempt to receive a recommendation for a menu item that is consistent with his likes, dislikes, particular diet, allergies, etc., or when a user searches for a recipe. The FE could, alternatively, be initiated by a food event provider (FEP), for example, a restaurant, when the user enters a vicinity of the restaurant with his smartphone. These are, however, just examples, and the FE could be any of the many FEs described in detail herein.

Further, one or more MSSCs may be identified (504). Referring to FIG. 3b, for example, the FEPP 325 may identify one or more MSSCs of the FEPP (e.g., MSSC Y 324) that are designated for processing the FE. The MSSCs are described in detail above and, therefore, are not described here.

Information may be obtained about a user of the WRTU. Referring to FIG. 4, for example, the FEPP 410 may obtain the information about the user (506), and the information may have been deduced from information that has been collected regarding transactions the user has engaged in via the WRTU. Such deduced information is described in more detail above with regard to machine learning. As with the examples described above, the information obtained (506) may be deduced based on a number of different attributes, including, for example, historical information regarding transactions the user has engaged in, such as searching for recipes including a particular ingredient, purchasing certain spices, or context information for the WRTU, such as a time of a transaction, a location of the device, etc.

Attributes may be communicated to the one or more MSSCs (508). Referring to FIG. 3b, for example, the FEPP 325 may communicate a set of attributes related to the FE to the identified one or more MSSCs. These attributes may include any type of attribute regarding an FE that may be helpful or necessary for the MSSC to carry out necessary processing functions with regard to the FE and may include, by way of non-limiting example, location, time, name of food event processor, Standard Industrial Code (SIC), Inventory information (e.g., SKU, GIC code, PLU), interaction method (e.g., online or in person), food event category (e.g., visit of recipe community, visit of cooking community, management of recipe box, recipe search, interaction with published, interaction with publishing site, exposure to ad network, use of product guide, interaction with restaurant, coupon processing, interaction with farmer or interaction with agricultural platform), food retailer category (e.g., butcher shop, cafe, convenience store, food hall, health food store, supermarket, hypermarket, coop, or online grocer), restaurant category (e.g., quick serve, fast-casual, mid scale, upscale, full service or meal delivery), action (e.g., browsing, inquiring, selecting, purchasing, fulfilling, paying or returning), selection method (e.g., free form or menu selection) and assistance method (e.g., software, human, combination or none).

Communication may be established with a processing system associated with a provider of the FE (510). In the examples illustrated in FIGS. 3b and 4, the FEPP 325 or 410 may establish the communication with the processing system associated with the FE, such as the FEPPS 404.

It may be determined whether an affirmative action is required from the user (512). In the examples illustrated in FIGS. 3b and 4, the FEPP 325 or 410 may determine whether the affirmative action is required. In an embodiment, the FEPP may determine whether the affirmative action is required by reading a confidence level, which may be set by the user or determined by any other method, as described in detail above. The confidence level may indicate a threshold level of accuracy that the deduced information is required to meet without affirmative action by the user to confirm the accuracy of the deduced information. A determined accuracy of the deduced information may be compared with the read confidence level. On a condition that the determined accuracy is below the read confidence level, a FEIT may be generated and sent to the WRTU of the user.

In the machine learning examples described above, for example, it may be necessary to confirm whether the machine learning is accurate. For example, if a user makes repeat trips to a particular fast food restaurant, machine learning may be used to deduce that the user likes that particular type of food. However, the user may just be going to that restaurant because she has had a number of busy days and has no time to eat. Depending on the confidence level that has been set, she may be prompted to confirm whether she actually likes that restaurant or type of food so that she is not bothered with similar recommendations if she does not actually like that restaurant or type of food.

In another embodiment, the FEPP may determine that no affirmative action is required from the user by determining whether the user has previously specified that no affirmative action is required. In one non-limiting example, the user may provide an affirmative action indicating the user's approval to send certain information to the FEP in one instance. And the user may specify at that time that it is not necessary to send a request for affirmative action in the future. This is referred to as an implicit FEIT in some of the embodiments described above.

On a condition that it is determined that no affirmative action from the user is required, the FEPP may not send a FEIT (514). On a condition that it is determined that affirmative action from the user is required, a FEIT may be generated that includes a request for affirmative action by user (516). In an embodiment, the FEPP 325 or 410 may generate and send the FEIT to the WRTU of the user.

The user may provide a response to the FEIT. For example, the user may hear a sound on the WRTU or see a notification display on the screen of the WRTU and may interact with the WRTU to send a “yes” or “no” or some other response to the FEIT. The FEPP may receive and process the response to the FEIT (518) and forward it to the one or more identified MSSCs (520). If the response is positive (e.g., “yes”), the deduced information may be provided to the processing system associated with the provider of the FE, such as the Food Event Provider Processing System (FEPPS) (404) illustrated in FIG. 4, in accordance with a policy of the profiling manager (e.g., PM 411), to enable the processing system associated with the provider of the FE to begin processing the FE (522).

In an embodiment, the FE is processed between the WRTU and the FEPPS. For example, the WRTU may initiate the FE when the user uses the WRTU to scan a code on a menu. The scanning action may trigger an FE, such as providing a recommended menu item to the user, that may require processing on both the end of the WRTU (which receives the recommendation and provides some form of authorization to share information about the user with the FEPPS) and the FEPPS (which needs to obtain information about the user and ultimately to provide the recommendation to the user based on that information).

In embodiments, the one or more MSSCs may process the FE in any number of different ways. In one example, the one or more MSSCs process the FE by performing at least one of creating a profile for the user, reading a pre-set profile of the user, updating the pre-set profile of the user or deleting a part or all of the pre-set profile of the user. In another example, the one or more MSSCs process the FE by performing at least one of creating attributes associated with the provider of the FE, reading attributes associated with the provider of the FE, updating attributes associated with the provider of the FE or deleting a part or all of a set of attributes associated with the provider of the FE. In another example, the one or more MSSCs process the FE by performing at least one of creating FE attributes, reading FE attributes, updating FE attributes or delating a part or all of a set of attributes associated with the FE.

In an embodiment, the FEIT may be placed in a queue for processing.

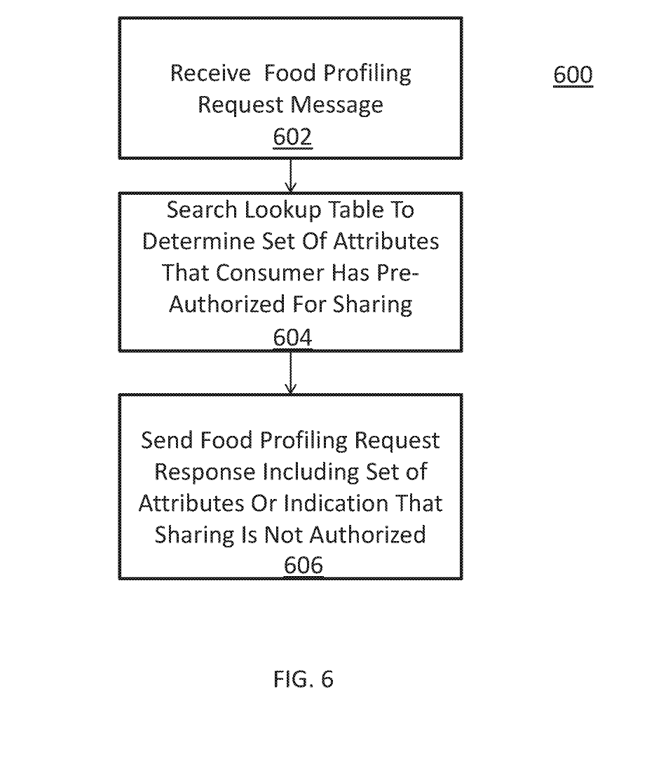

FIG. 6 is a flow diagram 600 of another example method for consumer profiling in support of food-related activities. In the example illustrated in FIG. 6, a Food Profiling Request Message (FPREM) is received (602). In an embodiment, a PM server, such as PM server 254 or 411, receives the FPREM from a WRTU of a consumer in response to the WRTU initiating a food-related event (FE). For example, when the WRTU initiates an FE, as described in more detail above, the provider of the FE (FEP) may respond by sending an Input Mobile Element (IME) to the WRTU. The IME may include code that may be used by the WRTU in processing the FE. In an embodiment, the IME includes code that provides a link to other code that directs the FPREM to the PM server. The FPREM may be created from information included in the IME and may include an identifier for the FE (FEID) and a consumer profile class (CFPC), which may identify a set of attributes that have been pre-authorized by the user for sharing with respect to the FE.

For example, a user may have a pre-set profile stored on a server. The pre-set profile may include information that the user has entered, such as his food allergies, a diet he is following, a religious diet he follows, ingredients he likes and dislikes, or any other attributes, such as have been provided as examples herein. The pre-set profile may also include other information, such as information gathered as a result of machine learning, including attributes such as foods an application or other software has deduced that the user likes or dislikes, or any other information, such as have been provided as examples herein. These may all be stored as attributes in the user's profile. The user may not, however, want to share all of the attributes with everyone, as a matter of privacy, security, etc. Accordingly, preferences may be set and stored along with the user's profile that direct the server as to what attributes to share with who. This information may be listed, for example, in a lookup table, that includes different CFPCs, each of which corresponds to a set of attributes and one or more FEIDs that the set of attributes may be shared with respect to. This may include attributes that are only for sharing with respect to particular FEIDs, attributes that are for sharing with all FEIDs, etc.

When the FPREM is received, a lookup table may be searched for the FEID and the CFPC to determine a set of attributes that the consumer has pre-authorized for sharing in association with the FE that corresponds to the FEID (604). In an embodiment, the PM server, such as PM server 254 or 411, performs the lookup table search.

A Food Profiling Request Response (PFRER) may be sent to a processing system associated with the FEP (FEPPS) (606). In an embodiment, the PM server, such as PM server 254 or 411, sends the PFRER to the FEPPS, such as the FEPPS 404, and the PFRER includes the FEID and either the set of attributes that the consumer has pre-authorized for sharing in association with the food-related event or an indication that the user has not authorized sharing of any attributes with the FEPPS.

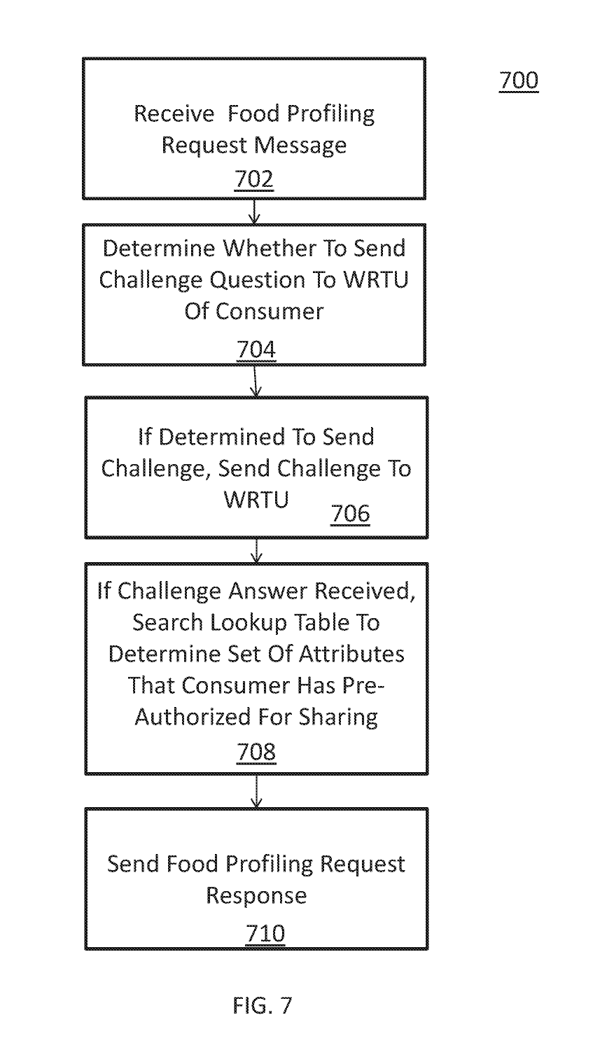

FIG. 7 is a flow diagram 700 of another example method for consumer profiling in support of food-related activities. In the example illustrated in FIG. 7, a FPREM is received (702). In an embodiment, a PM server, such as PM server 254 or 411, receives the FPREM from a WRTU of a consumer in response to the WRTU initiating a food-related event (FE). The FPREM may include an FEID and a CFPC.

It may be determined whether to send a challenge question to the WRTU of the consumer (704). In an embodiment, a PM server, such as PM server 254 or 411, determines whether to send the challenge question based on information collected from and about the consumer. How to determine whether to send such a challenge question is described in detail above so is not further described here. On a condition that it is determined to send the challenge question, the challenge question may be sent to the WRTU of the consumer (706). In an embodiment, the PM server may send the challenge question to the WRTU.

The user may or may not respond to the challenge question. As with previously described embodiments, the user may be alerted to the presence of the challenge question on his WRTU in a number of different ways. On a condition that an answer to the challenge question is received from the WRTU, a lookup table may be searched for the FEID and the CFPC to determine a set of attributes that the consumer has pre-authorized for sharing in association with the FE that corresponds to the FEID (708). The search of the lookup table may be performed, for example, by the PM server. An FPRER may be sent to the FEPPS (710). In an embodiment, the PM server may send the FPRER to the FEPPS, such as the FEPPS 404, and the FPRER may contain the set of attributes that the consumer has pre-authorized for sharing in association with the FE.

In embodiments of the methods described with respect to FIGS. 6 and 7, the WRTU initiating the FE may include, for example, scanning a menu at a restaurant, searching for a recipe, requesting a recommendation for a menu item from a restaurant, requesting a modification of a recipe, requesting review of a shopping list, or any other FE, such as described in the examples provided herein. The FEPPS may require information from the profile of the user in order to provide FE processing, such as providing a recipe recommendation that is consistent with the user's profile, a recommendation for a menu item from a restaurant that is consistent with the user's profile, a modification of a recipe that complies with the user's profile or an approval or suggested modifications to a shopping list, consistent with the user's profile.

In embodiments, the PM or other server or device may receive at least one additional attribute from the FEPPS that is generated based on information that was obtained by the FEPPS as a result of executing the FE. For example, if the FE is providing a recommended menu item to the user based on information in the user's profile, the user may provide feedback that she liked the menu item, and information about the user may be deduced from the feedback. The user's profile may be adapted according to the received at least one additional attribute.

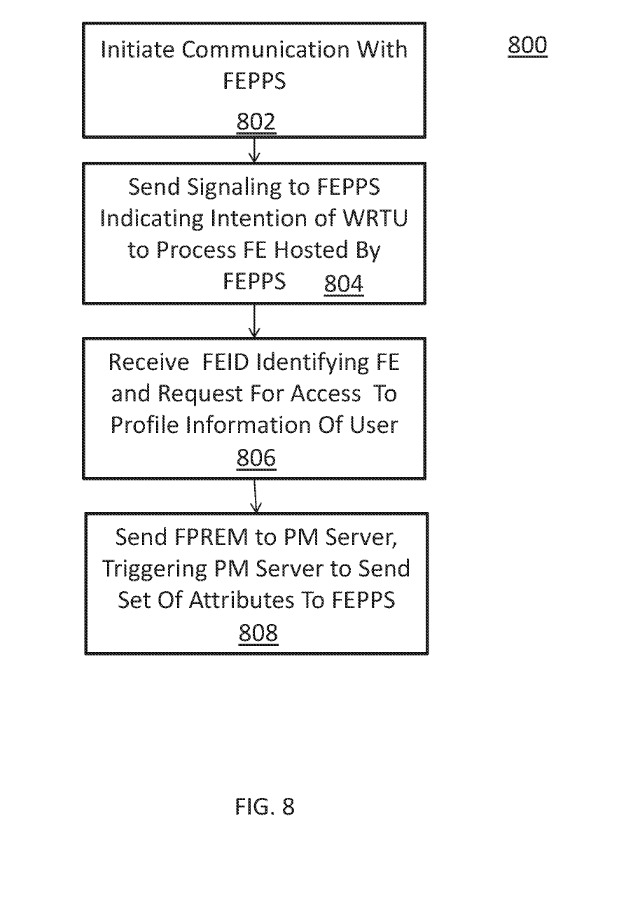

FIG. 8 is a flow diagram 800 of another example method for consumer profiling in support of food-related activities. In the example illustrated in FIG. 8, communication may be initiated with the FEPPS (802). In an embodiment, a WRTU, such as device 114, 202, 206, 301 or 401, may initiate communication with the FEPPS, such as the FEPPS 404. The WRTU may also send signaling to the FEPPS indicating an intention of the WRTU to process an FE hosted by the FEPPS (804).

In response to the signaling, the WRTU may receive an FEID that identifies the FE and may also receive a request for access to profile information associated with the user of the WRTU (806). In response to receiving the FEID, the WRTU may send an FPREM to a PM server (808). The FPREM may include the FEID and a CFPC that identifies a set of attributes associated with a profile of the user that the consumer has pre-authorized for sharing in association with the FE that corresponds to the FEID. The FPREM may trigger the PM server to send the set of attributes to the FEPPS for use in processing the FE in accordance with agreed usage rules.

While much of the preceding specification references, a consumer as the focal point for the activities discussed, it should be recognized that often the more general term user is more appropriate. This is because, although the overall utilization of the techniques, programs, and devices discussed are indeed ultimately meant to support the needs of consumers, there are other users involved in order to make the consumer's experience a value added endeavor.

While much of the preceding specification references a WRTU as the focal point for the various activities discussed, it should be recognized that users may have more than WRTU. They have a collection of WRTUs. All or part of the user's WRTU collection can be involved in the operation of this invention.

The references cited throughout this application, are incorporated for all purposes apparent herein and in the references themselves as if each reference was fully set forth. For the sake of presentation, specific ones of these references are cited at particular locations herein. A citation of a reference at a particular location indicates a manner in which the teachings of the reference are incorporated. However, a citation of a reference at a particular location does not limit the manner in which all of the teachings of the cited reference are incorporated for all purposes.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method, implemented in a profile manager (PM) server, the method comprising:
receiving a Food Profiling Request Message (FPREM), from a Wireless Receive/Transmit Unit (WRTU) of a consumer, in response to the WRTU initiating a food-related event, wherein the FPREM:
is created from information included in an Input Mobile Element (IME) that is sent to the WRTU from a provider of the food-related event (FEP) in response to the WRTU initiating the food-related event, wherein the IME includes code that provides a link to other code that directs the FPREM to the PM server, and
includes an identifier for the food-related event (FEID) and a consumer food profile class (CFPC);
searching a lookup table for the FEID and the CFPC to determine a set of attributes that the consumer has pre-authorized for sharing in association with the food-related event that corresponds to the FEID; and
sending, to a processing system associated with the FEP (FEPPS), a Food Profiling Request Response (PFRER), wherein the PFRER includes the FEID and one of the set of attributes that the consumer has pre-authorized for sharing in association with the food-related event or an indication that the user has not authorized sharing of any attributes with the FEPPS.

2. The method of claim 1, wherein the WRTU initiating the food-related event includes one of scanning a menu at a restaurant, searching for a recipe, requesting a recommendation for a menu item from a restaurant, requesting a modification of a recipe, or requesting review of a shopping list, such that the FEPPS requires information from a profile of the user in order to provide one of the recipe that is consistent with the profile of the user, the recommendation for the menu item from the restaurant that is consistent with the profile of the user, the modification of the recipe consistent with the profile of the user, or an approval or suggested modifications to the shopping list consistent with the profile of the user.

3. The method of claim 1, wherein the set of attributes include some or all of the attributes associated with a profile of the user, and the attributes associated with the profile of the user include one or more of a medical condition of the consumer, a food allergy of the consumer, a diet that the consumer complies with, an ingredient that the consumer prefers, and an ingredient that the consumer does not prefer.

4. The method of claim 1, further comprising:
receiving at least one additional attribute from the FEPPS, the at least one additional attribute being generated based on information that was obtained by the FEPPS as a result of executing the food-related event; and
adapting the profile of the user according to the received at least one additional attribute.

5. A method, implemented in a profile manager (PM) server, the method comprising:
receiving a Food Profiling Request Message (FPREM), from a Wireless Receive/Transmit Unit (WRTU) of a consumer, in response to the WRTU initiating a food-related event (FE), wherein the FPREM includes an identifier for the FE (FEID) and a consumer food profile class (CFPC);
determining whether to send a challenge question to the WRTU of the consumer based on information collected from and about the consumer;
on a condition that it is determined to send the challenge question, sending the challenge question to the WRTU of the consumer;
on a condition that a challenge answer to the challenge questions is received from the WRTU:
searching a lookup table for the FEID and the CFPC to determine a set of attributes that the consumer has pre-authorized for sharing in association with the food-related event that corresponds to the FEID, and
sending, to a processing system associated with a provider of the FE (FEPPS), a Food Profiling Request Response (PFRER) containing the set of attributes that the consumer has pre-authorized for sharing in association with the food-related event.

6. The method of claim 5, wherein the WRTU initiating the food-related event includes one of scanning a menu at a restaurant, searching for a recipe, requesting a recommendation for a menu item from a restaurant, requesting a modification of a recipe, or requesting review of a shopping list, such that the FEPPS requires information from a profile of the user in order to provide one of the recipe that is consistent with the profile of the user, the recommendation for the menu item from the restaurant that is consistent with the profile of the user, the modification of the recipe consistent with the profile of the user, or an approval or suggested modifications to the shopping list consistent with the profile of the user.

7. The method of claim 5, wherein the set of attributes include some or all of the attributes associated with a profile of the user, and the attributes associated with the profile of the user include one or more of a medical condition of the consumer, a food allergy of the consumer, a diet that the consumer complies with, an ingredient that the consumer prefers, and an ingredient that the consumer does not prefer.

8. The method of claim 5, further comprising:
receiving at least one additional attribute from the FEPPS, the at least one additional attribute being generated based on information that was obtained by the FEPPS as a result of executing the food-related event; and
adapting the profile of the user according to the received at least one additional attribute.
